(19) United States
(12) Patent Application Publication
(10) Pub. No.: US 2025/0234915 A1
(43) Pub. Date: Jul. 24, 2025

(54) DUAL OPERATION BREADER SYSTEM AND METHOD

(71) Applicant: John Bean Technologies Corporation, Chicago, IL (US)

(72) Inventors: Ramesh M. Gunawardena, Solon, OH (US); Robert M. Stacy, Sandusky, OH (US); Vera Wong, Avon Lake, OH (US); Keith Gildenmeister, Vickery, OH (US); Todd Gerold, Berlin Heights, OH (US); Felipe Perozin, Araraquara (BR)

(73) Assignee: John Bean Technologies Corporation, Chicago, IL (US)

(21) Appl. No.: 18/421,685

(22) Filed: Jan. 24, 2024

(51) Int. Cl. A23P 20/12; B65G 41/00

(52) U.S. Cl. CPC A23P 20/12; B65G 41/002; B65G 2201/0202

(57) ABSTRACT

A linear coating apparatus may include a coating assembly configured to apply a layer of coating to the food product as it is moved along a conveyance path. A texturizing assembly for imparting a texture to the layer of coating may include: a selective compression assembly having rotating cylindrical wheels each having a length extending substantially across a width of the conveyor system and spaced horizontally along a length of the conveyor system. The rotating cylindrical wheels are configured to apply a tangential force to the coated food product as it travels by gravity through the selective compression assembly. The tangential forces apply compression to the layer of coating and the food product for creating a texture in the layer of coating. An infeed assembly is configured to deposit the coated food product vertically above an infeed end of the selective compression assembly with a trajectory.

### BACKGROUND

Prepared food products come in a wide variety of styles. Many prepared food products, whether ready-to-eat or those needing further cooking, are prepared with a coating that makes the food product more appealing. Such coated, prepared food products include entrees, appetizers, desserts (such as pastries, donuts), etc., and includes meats, fish, cheese, fruit and vegetables, etc. The types of coatings used on food products include dry coatings such as flour, bread crumbs, corn meal, sugar and spice and the like.

In the food preparation industry, food coatings are generally classified by appearance as flour breading, free flowing (such as cracker meal or bread crumbs), and Japanese-style crumbs which tend to be elongate and crispy. Food coatings may also include seasonings, spices, shortening, etc., as needed to add flavor and texture to the food product. Other coatings such as ground cereal, dried vegetables or the like, may also be employed. Some food products have a batter applied to them before the coating or topping is applied.

In the commercial production of prepared foods, a large variety of food products are machine-coated with breading, flour or the like before being fried, (or otherwise cooked) or simply frozen and packaged. While the automation of the food coating process is economically desirable, another goal of the food coating process is to make the coating appear to be “home-made.” However, most automatic food coating processes fail to make “home-style” appearing foods.

A “home-style breading” may simulate a breaded food product prepared in the home. This can be done, for example, by dipping food, such as pieces of raw chicken, in a bowl with beaten egg and then placing the egg coated food into a bag containing flour and optionally spices, herbs, seasonings, shortening, etc., to form a coating which adds flavor and texture to the product. Other coating material such as ground cereal, dried vegetables or the like may be used as desired. The bag is moved back and forth to coat the many surfaces of the food product. This technique can be useful for coating food products having many, oftentimes hidden surfaces, such as chicken, because in moving the bag, the surfaces of the food products are exposed to the coating. The technique is also useful for coating various other food products. The flour coated food is then fried in a frying pan or deep fryer in the home.

Generally, the food industry prefers to use an automated and continuous food coating process wherever possible while still achieving a “home-style” look. Home style coating is typically a final appearance where the surface of the product has a rough appearance as though it was handmade/homemade, typically with a combination of hand kneading and tossing in a coating. The rough appearance differentiates the home style product from a “machine processed” smoother appearance. Home style coating is typically a flour-based coating as compared to a crunchy crumb.

The home style appearance is frequently accomplished by flipping or rolling a battered substrate, most commonly completed in a flighted rotary drum breader for the final application of flour breading. The hollow drum includes axial ribs along inner surfaces of the drum. The food products to be coated are added to the drum via a conveyor that drops food products into the drum. The drum rotates so that the food products are tumbled along with the breading. The tumbling process unfolds food products that are folded and exposes surfaces of the food products to the breading.

A liquid or batter is typically applied to the outer surface of the food product prior to placing it in the rotary drum, to facilitate adhesion of the breading material to the food product. The breading material in the drum breader may also be seeded (e.g., a small amount of moisture is added, either batter mix or water) to allow the breading to clump slightly. The seeded breading then adheres to the surface of the product, creating the rough home style look. The amount of moisture added and the speed at which the product passes through the drum breader will vary the intensity of the home style look.

Although producing a desired coating appearance and texture, a rotary drum breader has numerous drawbacks. For instance, there are limits to the number of food products that can be tumbled together at any one time. Moreover, a long time of engagement or tumbling time is required for effective coating. For instance, it may take a food product around 12-15 seconds to traverse the length of the rotating drum from entry to discharge. Accordingly, the efficiency of rotary drum breaders is limited.

Additionally, breaded food products generally exit the rotary drum in a heap, requiring labor or machinery to separate the breaded product across a belt for further processing (e.g., packaging, cooking, freezing, etc.). It also can result in low quality food products if food is not properly redistributed along the conveyor width. For example, food can be clumped together and then the next step in the food processing is not carried out in an optimal way. Where food is frozen after being on the downstream conveyor, clumps of food can be frozen together, making weighing, cooking, and packaging of it very difficult and oftentimes resulting in costly waste. Because of the ancillary equipment that is often needed to spread and align the product, home style lines can get very long and therefore can be difficult to accommodate. Disruption of the breaded food products during separation may also result in loss of the breading material. In addition, drum style breaders are often difficult to clean and require intensive maintenance.

Further, the drum breader is not very effective at sifting flour that has not adhered to the food product. Because of this, excess coating is often discharged from the drum breader along with the food product where it either falls to the floor causing waste or is carried down stream causing problems with further processes such as ruining the oil in a fryer.

More recently, linear assembly breaders that maintain product spread across a width of a belt (e.g., the number of products across the belt width X the number rows) have been introduced in an effort to better coat food product and more closely replicate hand breading and/or a batch coating process. Such linear assembly breaders may include multiple conveyors, tumblers, or flighted wheels placed along a linear and at least somewhat vertical path. Food products may be dropped from one conveyor/tumbler/wheel to another, sometimes hitting bars or other assemblies meant to flip the food product so that, in theory, all sides of the food product are exposed to breading materials. As the product drops from one conveyor/tumbler/wheel to the next, much of the breading material is actually dislodged from the surface of the food product. While multiple flipping conveyors/tumblers/wheel aid in exposing all sides of the food product to the breading material, it is difficult to achieve a consistent uniform coating of thick breading, as desired for “home style” breading. Moreover, these prior art linear assembly “home style” breaders have a similar, long dwell time as a rotary drum breader.

Other types of food coating devices, such as for non-home style looks, may employ endless conveyor mesh belts having various stations along their length. Food items are deposited on the belt at an infeed area and are coated with the coating mixture on the bottom surface. The conveyor belt carries the food items under a “waterfall” of food coating that covers the top surface of the food items. Mesh conveyor belt systems are suitable for applying coating to fragile food products, whereas a drum breader or the like may be used for applying a coating to durable food products (and to achieve a “home style” effect). Thus, at least two machines are typically required, increasing the overall footprint of the food coating line and necessitating extra maintenance.

### SUMMARY

In some aspects, the techniques described herein relate to a linear coating apparatus configured to apply coating to a food product passing therethrough, the linear coating apparatus including: a conveyor system supported in a frame and configured to move a food product along a conveyance path from an infeed end to a discharge end; a coating assembly configured to apply a layer of coating to the food product as the food product is moved along the conveyance path, wherein after passing through the coating assembly the food product is a coated food product having a layer of coating; and a texturizing assembly configured to impart a texture to the layer of coating, the texturizing assembly including: a selective compression assembly having at least first and second rotating cylindrical wheels each having a length extending substantially across a width of the conveyor system, the at least first and second rotating cylindrical wheels spaced horizontally along a length of the conveyor system, the first rotating cylindrical wheel configured to apply at least a first tangential force to the coated food product as the coated food product travels by gravity through the selective compression assembly and the second rotating cylindrical wheel configured to apply at least a second tangential force to the coated food product as the coated food product travels by gravity through the selective compression assembly, wherein the at least first and second tangential forces apply compression to at least one of the layer of coating and the food product for creating a texture in the layer of coating; and an infeed assembly configured to deposit the coated food product vertically above an infeed end of the selective compression assembly with a trajectory; wherein the coated food product having a texture in the layer of coating, after passing through the selective compression assembly, is deposited onto the conveyor system.

In some aspects, the techniques described herein relate to a dual function linear coating apparatus configured to apply coating to a food product passing therethrough in first and second configurations and to selectively apply texture to the coating of the food product in the second configuration, the linear coating apparatus including: a conveyor system supported in a frame and configured to move a food product along a conveyance path from an infeed end to a discharge end, the conveyor system including: an upstream conveyor system moveable between a first, substantially horizontal configuration and a second, lifted configuration; and a downstream conveyor system in substantially linear alignment with the upstream conveyor system when the upstream conveyor system is in the first, substantially horizontal configuration, wherein the downstream conveyor system and the upstream conveyor system define the conveyance path between the infeed end and the discharge end when the upstream conveyor system is in the first, substantially horizontal configuration; a coating assembly configured to apply a layer of coating to the food product as the food product is moved along the conveyance path; and a texturizing assembly configured to impart a texture to the layer of coating, the texturizing assembly including: a selective compression assembly having at least first and second rotating cylindrical wheels each having a length extending substantially across a width of the conveyor system, the at least first and second rotating cylindrical wheels spaced horizontally along a length of the conveyor system, the first rotating cylindrical wheel configured to apply at least a first tangential force to the coated food product as the coated food product travels by gravity through the selective compression assembly and the second rotating cylindrical wheel configured to apply at least a second tangential force to the coated food product as the coated food product travels by gravity through the selective compression assembly, wherein the at least first and second tangential forces apply compression to at least one of the layer of coating and the food product for creating a texture in the layer of coating; and an infeed assembly configured to deposit the coated food product vertically above an infeed end of the selective compression assembly with a trajectory; wherein the upstream conveyor system conveys the coated food product to the infeed assembly when the upstream conveyor system is in the second, lifted configuration, and wherein the coated food product having a texture in the layer of coating, after passing through the selective compression assembly, is deposited onto the downstream conveyor system.

In some aspects, the techniques described herein relate to a method of texturizing a coated food product, including: conveying a coated food product having a layer of coating to a texturizing assembly located above a conveyor system of a coating apparatus; depositing the coated food product into the texturizing assembly with a trajectory; applying at least first and second tangential forces to the coated food product as the coated food product travels by gravity through the texturizing assembly, wherein the at least first and second tangential forces apply compression to at least one of the layer of coating and the food product for creating a texture in the layer of coating; and depositing the coated food product having texture in the layer of coating onto the conveyor system.

In some aspects, the techniques described herein relate to a food product texture management system, including: a sensor assembly configured to capture sensor data of a coated food product having texture produced by a coating apparatus; a processor; and a memory storing instructions that, when executed by the processor, cause a computing device of the food product texture management system to: perform a texture analysis of the coated food product by comparing sensor data of the coated food product to a texture specification for the coated food product; and generate at least one of instructions and recommendations for adjusting at least one parameter of the coating apparatus based on the texture analysis.

In some aspects, the techniques described herein relate to a computer-implemented method of performing a texture analysis for a coated food product coated with a coating apparatus, the method including: capturing sensor data of a coated food product having texture; performing, with a computing device, a texture analysis of the coated food product by comparing sensor data of the coated food product to a texture specification for the coated food product; and generating, with a computing device, at least one of instructions and recommendations for adjusting at least one parameter of the coating apparatus based on the texture analysis.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows an isometric view of an exemplary coating apparatus formed in accordance with various aspects of the present disclosure.

FIG. 2 shows an isometric view of the exemplary coating apparatus of FIG. 1.

FIG. 3 shows an isometric view of the exemplary coating apparatus of FIG. 1, wherein a portion of a housing has been removed and wherein the coating apparatus is shown in a first, conventional style coating configuration.

FIG. 4 shows a front view of the exemplary coating apparatus of FIG. 1.

FIG. 5 shows a rear view of the exemplary coating apparatus of FIG. 1.

FIG. 6 shows a cross-sectional view of the exemplary coating apparatus of FIG. 1.

FIG. 7 shows an isometric view of the exemplary coating apparatus of FIG. 1, wherein a portion of a housing has been removed, and wherein the coating apparatus is in a second, home style coating configuration.

FIG. 8 shows a front view of the exemplary coating apparatus of FIG. 7.

FIG. 9 shows a rear view of the exemplary coating apparatus of FIG. 7.

FIG. 10A shows a cross-sectional view of the exemplary coating apparatus of FIG. 7.

FIG. 10B shows an operational view of an exemplary selective compression subassembly of the exemplary coating apparatus of FIG. 7.

FIG. 11A shows a cross-sectional view of an exemplary rotating cylindrical wheel of the exemplary selective compression subassembly if FIG. 10B.

FIG. 11A shows a top view of the exemplary rotating cylindrical wheel of FIG. 11A.

FIG. 11C shows an isometric view of the exemplary rotating cylindrical wheel of FIG. 11A.

FIG. 12 shows a block diagram of a non-limiting example of a food product texture management system according to various aspects of the present disclosure.

FIG. 13 is a block diagram of a non-limiting example of an apparatus computing device according to various aspects of the present disclosure.

FIG. 14 a flowchart that illustrates a non-limiting example of a method of managing texture of a food product.

FIG. 15 is a block diagram that illustrates a non-limiting example of a computing device appropriate for use as a computing device with examples of the present disclosure.

### DETAILED DESCRIPTION

Aspects of the present disclosure are directed to improved systems and methods for applying a coating to a workpiece, such as for applying breading to a food product. Using the systems and methods disclosed herein, an equivalent or superior “home style” type of coating may be achieved compared to rotary drum breaders. However, the “home style” type of coating may be achieved without the drawbacks of rotary drum breaders. For instance, using the systems and methods disclosed herein, the coated products are properly redistributed along the conveyor width at discharge (e.g., substantially spread across the width of the belt) without using any additional personnel or equipment. Moreover, the systems and methods disclosed herein can also be used to achieve the “home style” type of coating or another desired texture in significantly less time compared to, for instance, rotary drum breaders.

The systems and methods disclosed herein may also be used to achieve a variety of coated food products, including a “home style” type of coating and conventional coating. Such variety may be achieved with a single machine having a multiple coating operation capability with a simple and fast changeover design. Minimal changeover time is required to switch between coating functions, and the overall footprint of the machine is maintained. The machine is also designed to substantially prevent accumulation of wet coatings on functional machine elements, thereby eliminating machine jamming and/or wasteful consumption of input coatings. Further, the machine is hygienic and provides easy access for cleaning, maintenance, inspection, etc.

The foregoing benefits as well as other benefits will be further appreciated from the description that follows.

In the present disclosure, references to “food,” “food products,” “food pieces,” “food items,” “food stuffs”, “pieces,” “work product”, “work piece”, “substrate”, “portions,” etc., are used interchangeably and are meant to include all types of foods. Such foods may include meat, fish, poultry, plant-based products, fruits, vegetables, nuts, or other types of foods. Also, the systems and methods disclosed herein are directed to raw food products, as well as partially and/or fully processed or cooked food products.

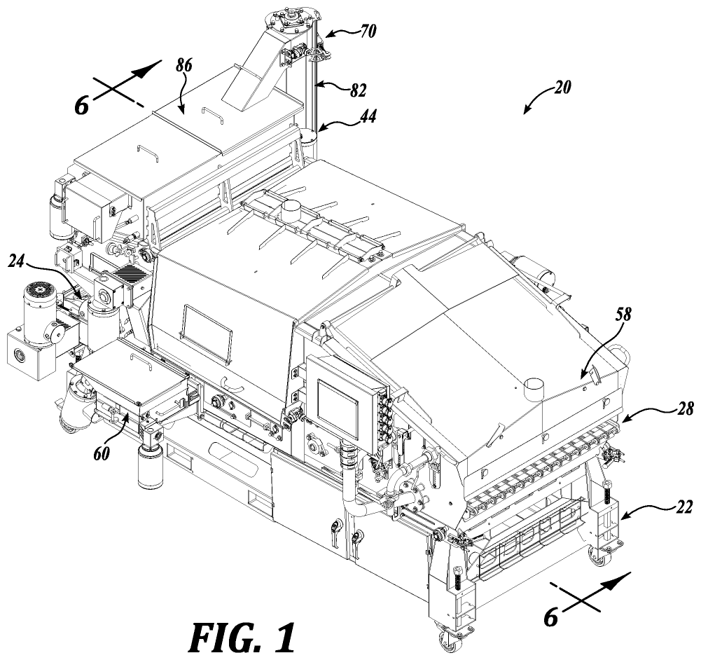

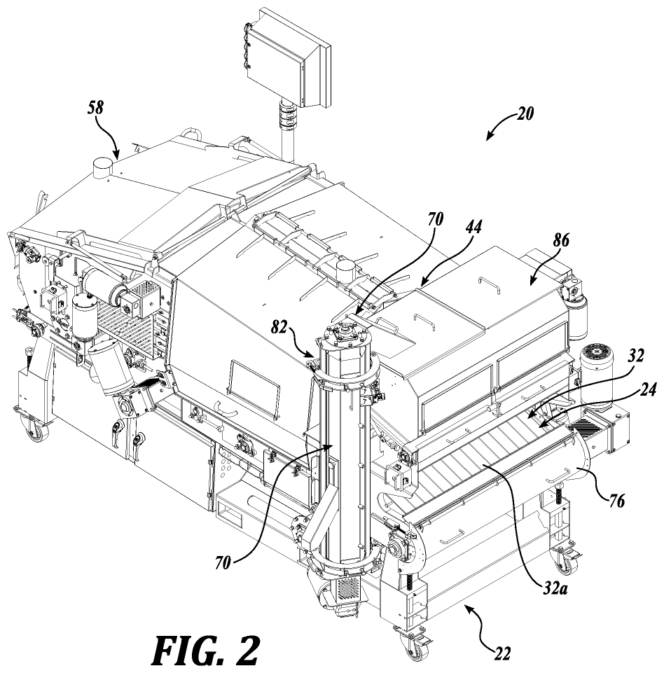

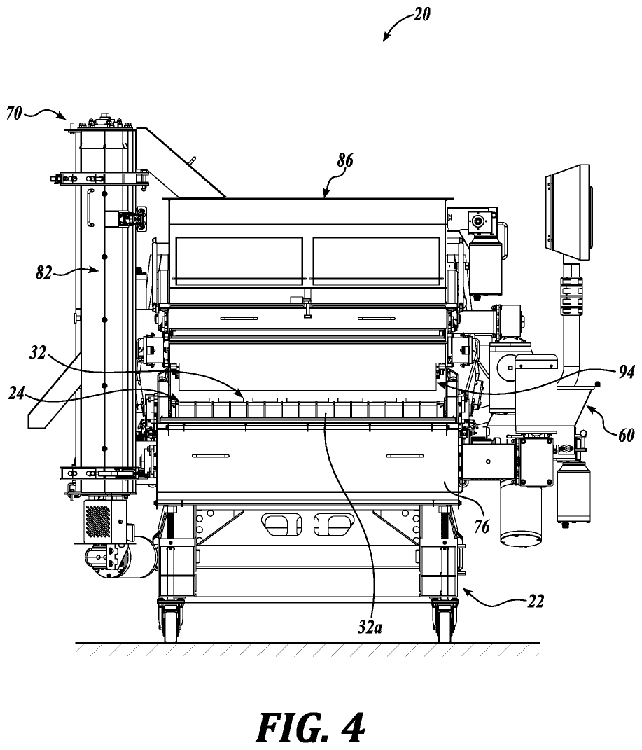

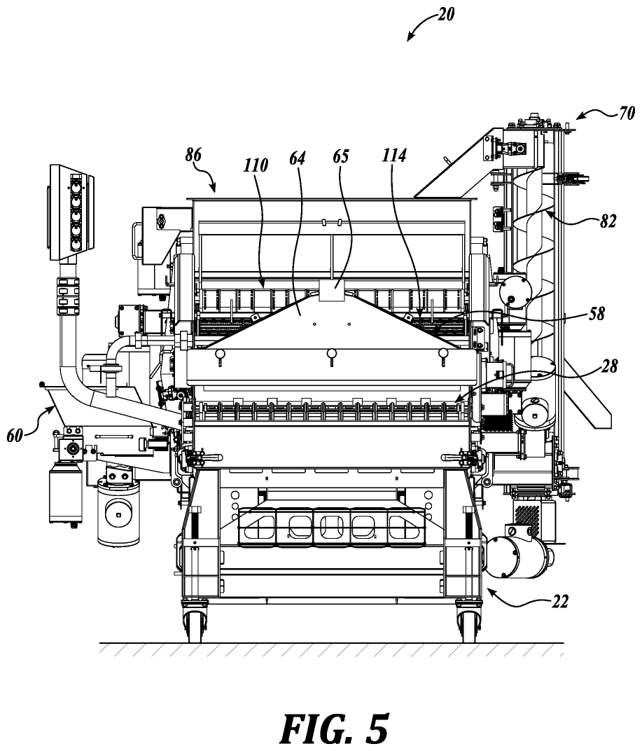

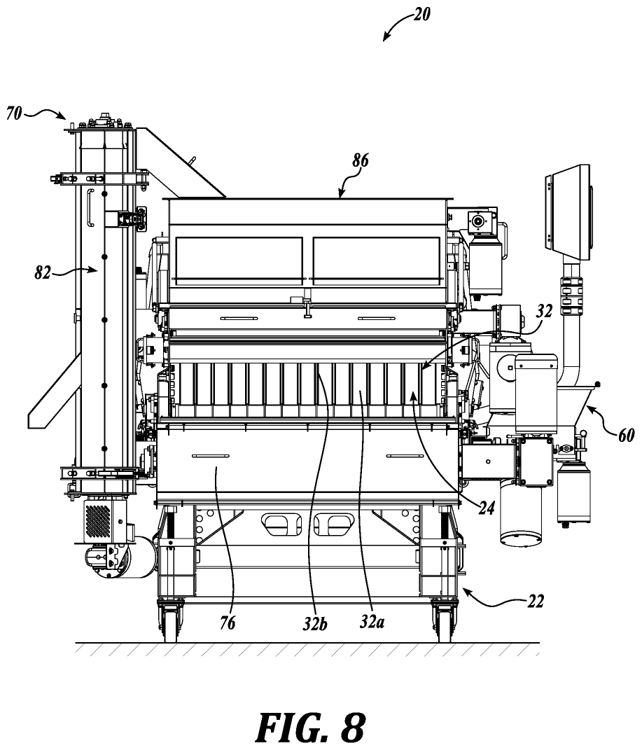

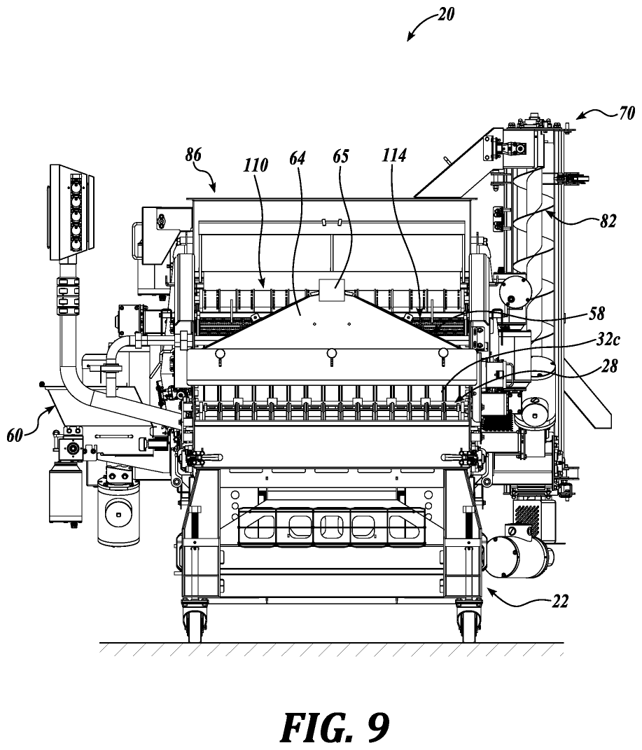

An exemplary dual function linear coating apparatus 20 will now be described with reference to FIGS. 1-11. The dual function linear coating apparatus 20 is generally configured for coating a food product in a manner to provide at least the benefits described above. For instance, the exemplary dual function linear coating apparatus 20 can be used to produce a “home style” type of coating (or another desired texture) that is equivalent to or superior to that achieved with rotary drum breaders, but in less time, with proper belt distribution at discharge, and while optimizing cleaning, maintenance, inspection, etc. The dual function linear coating apparatus 20 can also be configured for use in “conventional” coating applications, necessitating only a simple changeover between configurations and without increasing the overall footprint of the apparatus.

The dual function linear coating apparatus 20, hereinafter referred to as “coating apparatus 20” for simplicity, includes a frame 22 defining an enclosure for components of the coating apparatus 20. The frame 22 may be configured as an elongated structure constructed of sheet metal or the like to form an enclosed box-like structure in which breading material is introduced and distributed for application to food products. The frame 22 may be mounted on a suitable support system so as to allow the coating apparatus 20 to be utilized in association with an upstream batter applying machine and/or to directly feed coated food products into a suitable downstream thermal processing system (e.g., an oven, fryer, etc.).

The frame 22 supports an upstream endless pervious conveyor system 24 and a downstream endless pervious conveyor system 28. The upstream conveyor system 24 is defined by a plurality of belt runs within the frame 22 so as to carry food product along the first length of the frame 22 as well as to facilitate distribution of breading material within the machine. The downstream conveyor system 28 is defined by a plurality of belt runs within the frame 22 so as to carry food product along the second length of the coating apparatus 20 as well as to facilitate excess removal of and redistribution of breading material within the machine.

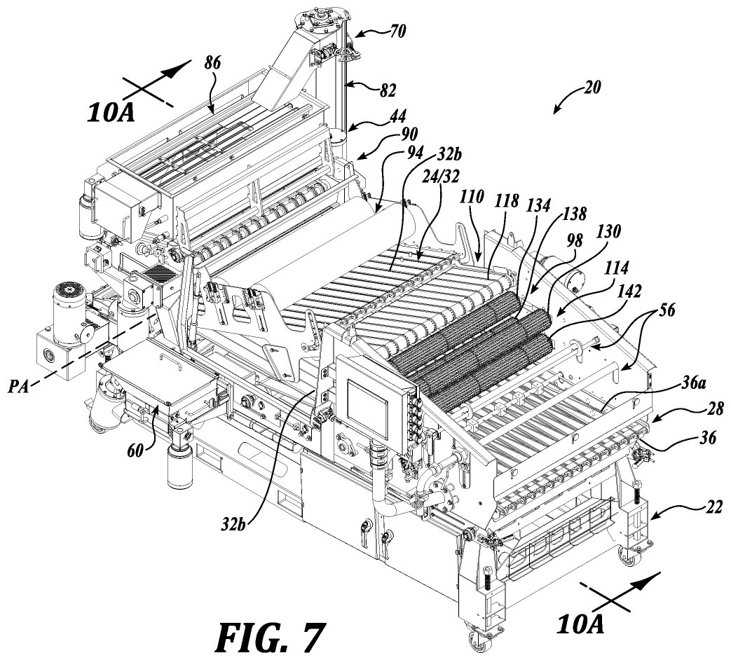

As noted above, the dual function linear coating apparatus 20 is configurable in one of two coating configurations. In a first “conventional coating” configuration, shown in FIGS. 1-6, the dual function linear coating apparatus 20 is configured as a standard linear coating apparatus or breader configured to apply a bottom and top layer of coating to a food product. In that regard, both the upstream conveyor system 24 and downstream conveyor system 28 are substantially horizontal and co-planar and define a substantially horizontal, linear conveyance path. In a second “home style” configuration, shown in FIGS. 7-10, the dual function linear coating apparatus 20 is configured to provide a linear, gravity induced path of travel for the food product through a texturizing assembly 98 after application of the bottom and top layer of coating. The upstream conveyor system 24 is moveable into a raised, inclined position for feeding coated food products to the texturizing assembly 98. Switching between the first and second configurations can be done solely through movement of the upstream conveyor system 24 into the raised, inclined position and does not increase the overall footprint of the apparatus.

Aspects of the upstream conveyor system 24 and downstream conveyor system 28 will be described with reference to FIGS. 1-6, with the dual function linear coating apparatus 20 shown in the first horizontal “conventional coating” configuration.

The upstream conveyor system 24 will first be described. The upstream conveyor system 24 includes an upstream conveyor belt 32 supported on a plurality of suitable roller members, such as first, second, third, fourth, and fifth rollers 34a-34e. A plurality of upstream conveyor belt runs are defined between each of the rollers along the conveyor path. A first upper belt run 32a extends upwardly and downstream from the first roller 34a located at the infeed end of the coating apparatus 20 to a second roller 34b. The first roller 34a may be driven by a suitable motor (e.g., a hydraulic motor) so as to continuously move the upstream conveyor belt 32 in a clockwise direction. The first upper belt run 32a supports food product infeed as well as bottom coating of the food product.

More specifically, food products may be deposited onto the first upper belt run 32a to enter the coating apparatus 20 for coating. For instance, food products may be introduced into the coating apparatus 20 from a suitable outlet conveyor of an upstream processing machine (e.g., a typical liquid batter machine, not shown) or otherwise introduced into the coating apparatus 20 through an infeed opening, so as to be disposed on an outer surface of first upper belt run 32a. The outer surface of the first upper belt run 32a carries a bottom layer of coating, which is deposited onto the first upper belt run 32a by a bottom layer coating assembly 40, described in more detail below. Thus, when the food products are deposited onto the first upper belt run 32a, they are received in a bottom layer of coating.

A second upper belt run 32b of the upstream conveyor belt 32 extends downstream from the first upper belt run 32a and the second roller 34b to the third roller 34c. The second upper belt run 32b is configured to support application of a top layer of coating to the food product. More specifically, a top layer of coating may be deposited onto the second upper belt run 32b and the food products received thereon by a top layer coating assembly 44, also described in more detail below.

The upstream conveyor belt 32 includes first and second intermediate return belt runs 32c and 32d configured for returning the upstream conveyor belt 32 to the infeed end of the coating apparatus 20 as well as for defining a fourth return belt run 32e. For instance, the first intermediate return belt run 32c extends downwardly and upstream from the second upper belt run 32b and from the third roller 34c to the fourth roller 34d. The second intermediate return belt run 32d extends downstream from the fourth roller 34d to the fifth roller 34e, which is located at the discharge or outfeed end of the coating apparatus 20. The fourth return belt run 32e extends upstream from the fifth roller 34e substantially along the length of the coating apparatus 20 between the fifth and first rollers 34e and 34a. The fourth return belt run 32e can carry excess coating along an upper surface of a bottom pan 48 extending along the length of the coating apparatus 20. It should be noted that the upstream conveyor system 24 may instead be any other configuration for carrying out the needed functions of the conveyors. In that regard, the descriptions and illustrations provided herein should not be seen as limiting.

The downstream conveyor system 28 will now be described in more detail. As noted above, the downstream conveyor system 28 is configured to carry food products along the second length of the coating apparatus 20 as well as to facilitate excess removal of and redistribution of breading material within the machine. The downstream conveyor system 28 includes a downstream conveyor belt 36 supported on a plurality of suitable rollers, such as first, second, third, and fourth rollers 38a-38d. A plurality of downstream conveyor belt runs are defined between each of the rollers along the conveyor path. The third roller 38c or another roller may be driven by a suitable motor (e.g., a hydraulic motor) so as to continuously move the downstream conveyor belt 36 in a clockwise direction.

An upper belt run 36a (not shown in entirety) of the downstream conveyor system 28 extends downstream from the first roller 38a, which is located substantially adjacent to the third roller 34c of the upstream conveyor system 24, to the second roller 38b located at the discharged or outfeed end of the coating apparatus 20. The upper belt run 36a of the downstream conveyor system 28 is substantially horizontal and substantially co-planar with the second upper belt run 32b of the upstream conveyor system 24. In that regard, food products may be transferred from the second upper belt run 32b of the upstream conveyor system 24 to the upper belt run 36a of the downstream conveyor system 28. When transferred onto the upper belt run 36a of the downstream conveyor system 28, the coated food products may be moved downstream to the discharged or outfeed end of the coating apparatus 20.

A plurality of return belt runs may be defined between the second roller 38b located at the discharge or outfeed end of the coating apparatus 20 and the first roller 38a located substantially adjacent to the third roller 34c of the upstream conveyor system 24. In the example shown, the downstream conveyor belt 36 includes first, second, and third return belt runs 36b, 36c, and 36d. The first return belt run 36b extends upstream from the second roller 38b to the third roller 38c, the second return belt run 36c extends downstream from the third roller 38c to the fourth roller 38d, and the third return belt run 36d extends upstream from the fourth roller 38d to the first roller 38a. It should be noted that the downstream conveyor system 28 may instead be any other configuration for carrying out the needed functions of the conveyors. In that regard, the descriptions and illustrations provided herein should not be seen as limiting.

Before exiting the coating apparatus 20, it is desirable to remove excess coating from the food products and the upper belt run 36a for reuse and/or to prevent issues with downstream processing (e.g., clogging in a fryer). In that regard, the coating apparatus 20 may include an excess coating removal system having one or more vibration assemblies 52 located near the upper belt run 36a for vibrating the upper belt run 36a. When vibrated, excess coating, such as on an upper surface of the upper belt run 36a, may be dislodged and fall through the openings in the upper belt run 36a. The excess coating removal system may further include one or more blower assemblies 56 located near the upper belt run 36a for blowing compressed air towards the food products and upper surface of the upper belt run 36a. The one or more blower assemblies 56 can assist in blowing off any excess coating on top of the food products. Any other suitable excess coating removal system may instead be used.

The coating apparatus 20 includes a dust evacuation assembly 58 configured to evacuate dust (e.g., coating particles) from the discharge end of the coating apparatus 20. As can be appreciated, when excess coating is vibrated and/or blown off the food products and upper belt run 36a of the downstream conveyor belt 36, particles of coating may become airborne. Such airborne dust particles can contaminate upstream and downstream machine components and assemblies and cause other problems. For instance, escaped dust from the discharge opening of the coating apparatus 20 is a safety hazard for machine operators and other personnel. Escaped dust can also contaminate other machines, such as downstream ovens or fryers. Accordingly, the dust evacuation assembly 58 is configured to suitably evacuate dust and other contaminants from the interior of the coating apparatus 20 before the dust escapes the discharge opening or another opening.

The dust evacuation assembly 58 may be configured as a vacuum nozzle head 64 connected to a suction source 65. The vacuum nozzle head 64 may be of a generally triangular shape and have a bottom elongated side width that extends across substantially the entire width of the downstream conveyor belt 36. An elongated nozzle head opening extends along the bottom elongated side of the vacuum nozzle head 64, and it is sized to define an appropriate suction level for sufficiently evacuating dust from the interior of the coating apparatus 20. In some examples, the nozzle head opening is also located near the discharge end of the coating apparatus 20, in substantial vertical alignment with the second roller 38b. In this manner, the dust evacuation assembly 58 substantially prevents escape of any dust particles from the discharge opening of the coating apparatus 20.

Exemplary aspects of the bottom layer coating assembly 40 will now be described. The bottom layer coating assembly 40 may be substantially similar to a bottom layer coating assembly shown and described in U.S. Pat. No. 6,117,235, incorporated by reference in its entirety, and/or the bottom layer coating assembly used in a commercially available conventional coating or breading machine, such as the Stein Ultra V Breading Applicator & Preduster available from JBT Corporation of Chicago, IL. Thus, only a brief description of the bottom layer coating assembly 40 will be hereinafter provided.

Generally, the bottom layer coating assembly 40 is configured as a flow conveyor assembly that is configured to deposit a layer of coating onto the outer surface of the first and second upper belt runs 32a and 32b of the upstream conveyor belt 32 after first introducing coating material into a space between the outer surface of the fourth return belt run 32e and the bottom pan 48. In that regard, the bottom layer coating assembly 40 may include a first hopper assembly 60 configured to allow the introduction of coating material (e.g., breading or pre-dust material) onto the fourth return belt run 32e/bottom pan 48 through an access opening 62 in the side of the coating apparatus enclosure, either manually, automatically, or semi-automatically. The access opening 62 may be located slightly above the space between the outer surface of the fourth return belt run 32e and the bottom pan 48 such that coating material flows by gravity into said space.

The pervious construction (e.g., open mesh) of the upstream conveyor belt 32 enables the fourth return belt run 32e to carry coating material along the surface of the bottom pan 48 towards the first roller 34a. The fourth return belt run 32e carries coating material received from the first hopper assembly 60, as well as excess coating material that falls from the upper belt run 36a, such as from the vibrations and air movement of the one or more vibration assemblies 52 and the one or more blower assemblies 56.

The carried coating material passes a bottom layer forming assembly 66, which forms a preliminary bottom layer of coating material having a suitable thickness. The forming assembly 66 allows only a certain thickness of coating material to pass underneath, such as ¾ inches or 1 inch. Any excess material that does not pass by the forming assembly 66 can be channeled to a second hopper assembly 70 for defining the top layer of coating through a cross feed screw assembly 68.

After passing the forming assembly 66, the coating material is pumped up over the rolled infeed end of the upstream conveyor system 24 and deposited onto a top surface of a top pan 72 disposed beneath the first upper belt run 32a and second upper belt run 32b. To facilitate such pumping of material, the coating apparatus 20 includes inner and out curved end plates 76 and 78 located adjacent inner and outer surfaces of the upstream conveyor belt 32. The inner and out curved end plates 76 and 78 are correspondingly shaped and sized to allow coating material to pass therebetween and be pumped/moved by the upstream conveyor belt 32 to the top pan/upper belt run. The pumped coating material moving along the top pan 72 by the upstream conveyor belt 32 defines the bottom coating layer against which food products may be deposited for coating.

As the food products are conveyed along the second upper belt run 32b, they receive a top layer of coating from the top layer coating assembly 44, as noted above. The top layer coating assembly 44 may be substantially similar to a top layer coating assembly shown and described in U.S. Pat. No. 6,117,235, incorporated herein, and/or a top layer coating assembly used in a commercially available conventional coating or breading machine, such as the Stein Ultra V Breading Applicator & Preduster available from JBT Corporation of Chicago, IL. Thus, only a brief description of the top layer coating assembly 44 will be hereinafter provided.

Generally, the top layer coating assembly 44 is configured to deposit a top layer of coating material onto the food products as they are conveyed past the assembly on the second upper belt run 32b. The top layer coating assembly 44 receives coating material from the second hopper assembly 70, which may be positioned at least in part adjacent to the enclosure of the coating assembly 20 near the infeed end of the coating apparatus 20. In the example shown, the second hopper assembly 70 includes a vertical screw assembly 82 configured to move coating material from a lower hopper portion in communication with the cross-feed screw assembly 68 (and optionally with another material source) to an upper hopper portion located above the upstream conveyor system 24.

The vertical screw assembly 82 moves material into a sifting assembly 86, which substantially prevents any large particles (e.g., pieces of food product, contaminants, etc.) from passing therethrough. Coating material that passes through the sifting assembly 86 then falls onto a transfer conveyor 88, which conveys the sifted coating material to a sprinkle assembly 90. A gate 92 may be positioned near a discharge end of the transfer conveyor 88 to control the amount of coating material deposited onto the sprinkle assembly 90. The sprinkle assembly 90 then deposits sifted coating material onto the top of the food products, such as in a waterfall fashion across the width of the second upper belt run 32b.

With a bottom and top layer of coating applied, the food products may pass a compression assembly 94 configured to apply pressure to top and bottom surfaces of the food products to pat the coating material onto the food products. The compression assembly 94 may include one or more deformable pressure rollers extending across the width of the upstream conveyor belt 32 and positioned above the second upper belt run 32b. Each roller has a longitudinal axis substantially transverse to the longitudinal axis of the upstream conveyor belt 32. Moreover, each roller has a deformable outer surface positioned above the outer nominal surface of the second upper belt run 32b in a spaced configuration to apply a suitable amount of pressure to the passing foods products. In that regard, the rollers of the compression assembly 94 may be adjustable in vertical location and/or size to accommodate food products of different sizes.

It should be appreciated that the bottom and top coating layers may instead be formed in any other suitable manner.

An overview of a conventional coating process using the coating apparatus 20 in the first configuration shown in FIGS. 1-6 will now be provided. In the first configuration, the coating apparatus 20 may be used to apply any suitable top and/or bottom layer of coating to a food product. For instance, the coating may be a pre-dust material (e.g., fine flour, cereal, etc.), a breading material (e.g., crumbs, flours, starches, flavoring materials, etc.), etc.

To start, the food products are deposited onto the first upper belt run 32a, such as by manual loading, automatically from another conveyance system, etc. The first upper belt run 32a carries a bottom layer of coating along the top pan 72. Thus, a bottom layer of coating is applied to the food products when they are deposited onto the first upper belt run 32a.

The food products, coated on the bottom, are conveyed onto the second upper belt run 32b, where the bottom layer of coating continues to be moved along with the food products. The food products are moved beneath the top layer coating assembly 44, where a top layer of coating is deposited onto the food products by the sprinkle assembly 90. The top and bottom coated food products then pass beneath the compression assembly 94, which packs the coating material onto the food products.

The top and bottom coated, packed food products are transferred to the upper belt run 36a of the downstream conveyor system 28, where they pass by the one or more vibration assemblies 52 and the one or more blower assemblies 56. Excess coating material is shaken and/or blown off the food products and upper belt run 36a, and it falls downwardly onto the fourth return belt run 32e. The fourth return belt run 32e moves the collected excess coating material to the cross-feed screw assembly 68, where it can be circulated to the second hopper assembly 70 for filtering and reuse. Coated food products exit the discharge opening of the coating apparatus 20 for further processing (e.g., thermal processing system such as an oven, fryer, freezer, etc., packaging, etc.).

The above description illustrates use of the coating apparatus 20 in the first, “conventional” configuration. As noted above, the coating apparatus 20 is also configured for use in a second “home style” configuration. Aspects of the coating apparatus 20 for supporting the second “home style” configuration will now be described with reference to FIGS. 7-11.

The coating apparatus 20, in the second “home style” configuration, is configured to move top and bottom coated food products from the upstream conveyor system 24 to a downstream, gravity-fed texturizing assembly 98. The texturizing assembly 98 is generally configured to impart a home style texture to the coated food products as the coated food products pass therethrough.

The texturizing assembly 98 is generally located vertically above the downstream conveyor system 28 and longitudinally along the conveyor axis between the compression assembly 94 and the excess coating removal assembly (e.g., the one or more vibration assemblies 52 and/or the one or more blower assemblies 56). In this manner, coated food products may be fed into the texturizing assembly 98, and after passing therethrough, the coated and textured food products fall onto the upper belt run 36a of the downstream conveyor belt 36. The coated and textured food products then continue along the upper belt run 36a past the excess coating removal assembly and to the discharge opening.

The top and bottom coated food products are conveyed to the texturizing assembly 98 by the upstream conveyor system 24 by moving the upstream conveyor system 24 into a lifted, second configuration. More specifically, the upstream conveyor system 24 is moveable from a first substantially horizontal configuration, where the second upper belt run 32b is substantially horizontal to support “conventional” coating, to a second lifted configuration, wherein a downstream end of the second upper belt run 32b is lifted and positioned to convey food products to the texturizing assembly 98. In this manner, the coating apparatus 20 may be changed over from the convention to the home style configuration without increasing or otherwise changing the overall footprint of the apparatus.

As will become appreciated from the description herein, the coating apparatus 20 is designed for rapid changeover from conventional to home style coating. In that regard, conversion between the first substantially horizontal configuration and the second lifted configuration is quick and easy. For instance, conversion between the first substantially horizontal configuration and the second lifted configuration in the coating apparatus 20 may take about 2 minutes with a simple actuation. By comparison, prior art systems often take at least 20 minutes to convert from a conventional coating apparatus to a home style coating apparatus and require removing components or other disassembly and assembly, which is up to 700% more time needed for a changeover. Further, prior art systems often require increasing or otherwise changing the overall footprint of the apparatus to change the configuration. The coating apparatus 20 can produce two fundamentally different types of textures through instantly switchable machine elements without increasing or otherwise changing the overall footprint of the apparatus.

The upstream conveyor system 24 may be moveable into the second lifted position through a suitable actuator assembly. For instance, a first linear actuator 104, such as a hydraulic or pneumatic actuator, may extend between the coating assembly frame 22 and a first conveyor assembly bracket 102 secured to a first side of the upstream conveyor system 24 along the second upper belt run 32b. A second linear actuator 109 may similarly extend between the coating assembly frame 22 and a second conveyor assembly bracket 103 secured to a second opposite side of the upstream conveyor system 24 along the second upper belt run 32b.

The first and second conveyor assembly brackets 102 and 103 may be secured to the first and second opposite sides of the upstream conveyor system 24 such that the conveyor system components along the second upper belt run 32b move together between the first and second configurations. For instance, the top pan 72, the second roller 34b, the third roller 34c, and the rollers of the compression assembly 94 are coupled to the first and second conveyor assembly brackets 102 and 103 such that those components, together with the second upper belt run 32b, move together between the first and second configurations. The second roller 34b, third roller 34c, and the rollers of the compression assembly 94 may also be journaled for rotation within the first and second conveyor assembly brackets 102 and 103 to facilitate rotation of those rollers in both configurations.

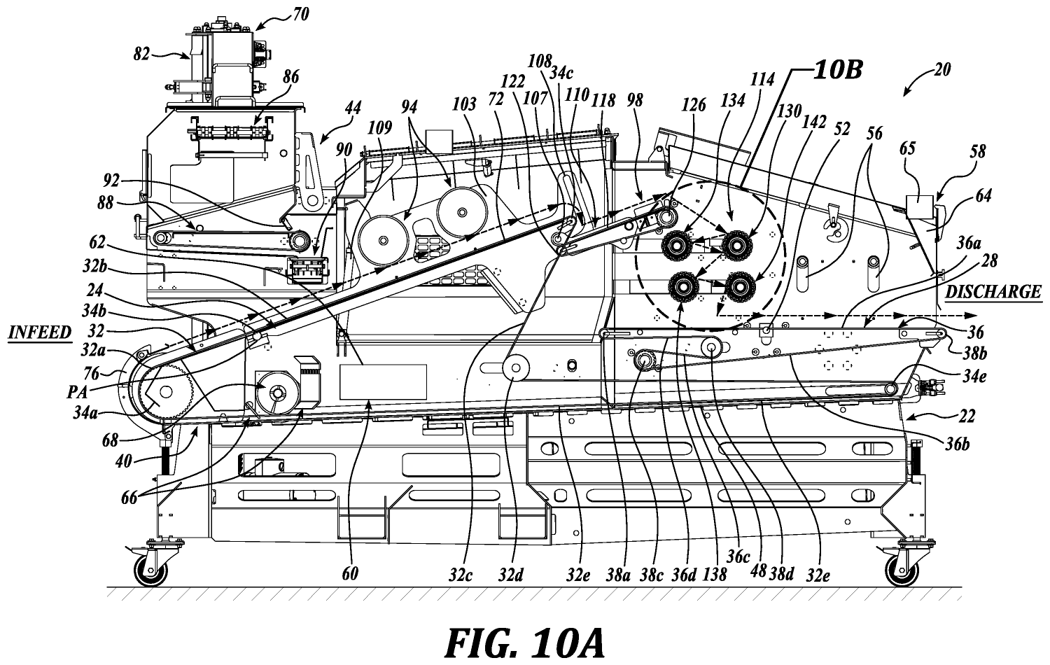

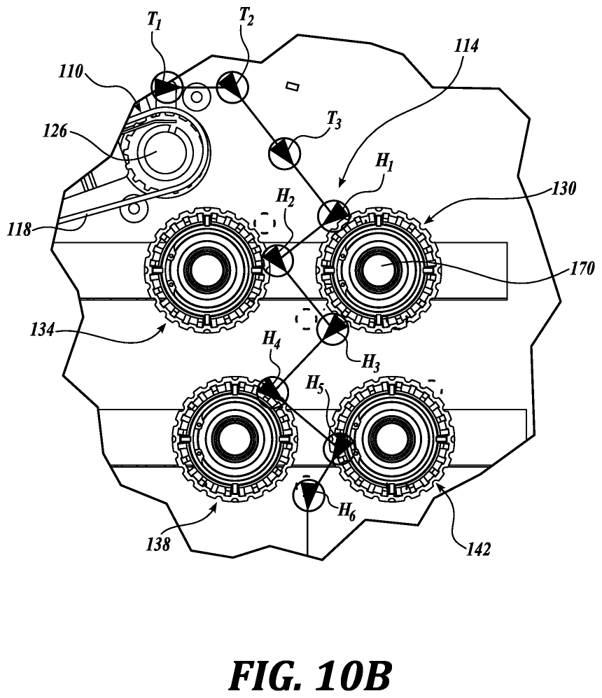

The actuator assembly, e.g., the first and second linear actuators 104 and 109, may be activated to move the first and second conveyor assembly brackets 102 and 103 upwardly about a pivot axis PA defined by the longitudinal axis of the second roller 34b. As can be seen in FIGS. 7 and 10A, as the first and second linear actuators 104 and 109 extend into an elongated position (e.g., a piston extends from a cylinder), the first and second conveyor assembly brackets 102 and 103 are moved upwardly away from the horizontal plane of the upper belt run 36a, pivoting about the pivot axis PA.

In the second configuration, the second upper belt run 32b is at an angle relative to horizontal, such as about 20 degrees, such that a discharge end of the second upper belt run 32b at the third roller 34c is positioned to deposit food products into the texturizing assembly 98. In the second configuration, the second upper belt run 32b may be substantially co-planar with the first upper belt run 32a. In that regard, the first upper belt run 32a may also be at an angle relative to horizontal, such as about 20 degrees. If the first upper belt run 32a was substantially horizontal, it would support the horizontal plane of the upstream conveyor belt 32 in the first “conventional style” configuration. However, when the second upper belt run 32b was moved into the second, lifted configuration, an obtuse angle would be formed between the first and second belt runs 32a and 32b, which could not be supported by an endless roller conveyor system. In other examples, the first upper belt run 32a may be eliminated and the second upper belt run 32b may instead extend along the length of the upstream conveyor system 24.

Exemplary aspects of the texturizing assembly 98 will now be described. As noted above, the texturizing assembly 98 is generally configured to impart a home style texture or another desired texture to the coated food products as the coated food products pass therethrough. Moreover, as will become appreciated, the texturizing assembly 98 is configured to achieve a home style texture of the same or better quality of a rotary drum breader, but without limiting throughput of treated food products or causing other problems commonly associated with a drum breader.

The texturizing assembly 98, as shown, includes a feed conveyor 110 positioned downstream of the second upper belt run 32b of the upstream conveyor system 24 and a selective compression subassembly 114 positioned downstream of the feed conveyor 110. Top and bottom coated food products are transferred onto the feed conveyor 110, and the products are then deposited into the selective compression subassembly 114 for texturizing, hydration, and pickup.

The feed conveyor 110 may generally include an endless conveyor belt 118 having a width that is substantially the same as the upstream and downstream conveyor systems 24 and 28 to substantially maintain product spread across the belt. The endless conveyor belt 118 extends between first and second transfer rollers 122 and 126 at upstream and downstream ends of the feed conveyor 110. The upstream end of the feed conveyor 110 (e.g., the first transfer roller 122 and a portion of the endless conveyor belt 118) is positional vertically beneath the second upper belt run 32b of the upstream conveyor system 24 and overlapping at least in part when the upstream conveyor system 24 is in the lifted, second configuration. In this manner, coated food products can be deposited onto the feed conveyor 110 from the second upper belt run 32b of the upstream conveyor system 24. Moreover, transferring of the coated food products from the second upper belt run 32b of the upstream conveyor system 24 onto the feed conveyor 110 may cause the coated food products to flip one hundred eighty degrees, which can assist in packing on the coating, distributing the coating on the food products, etc. However, it should be appreciated that in some examples, the coated food products are instead deposited into the selective compression subassembly 114 directly from the upstream conveyor system 24.

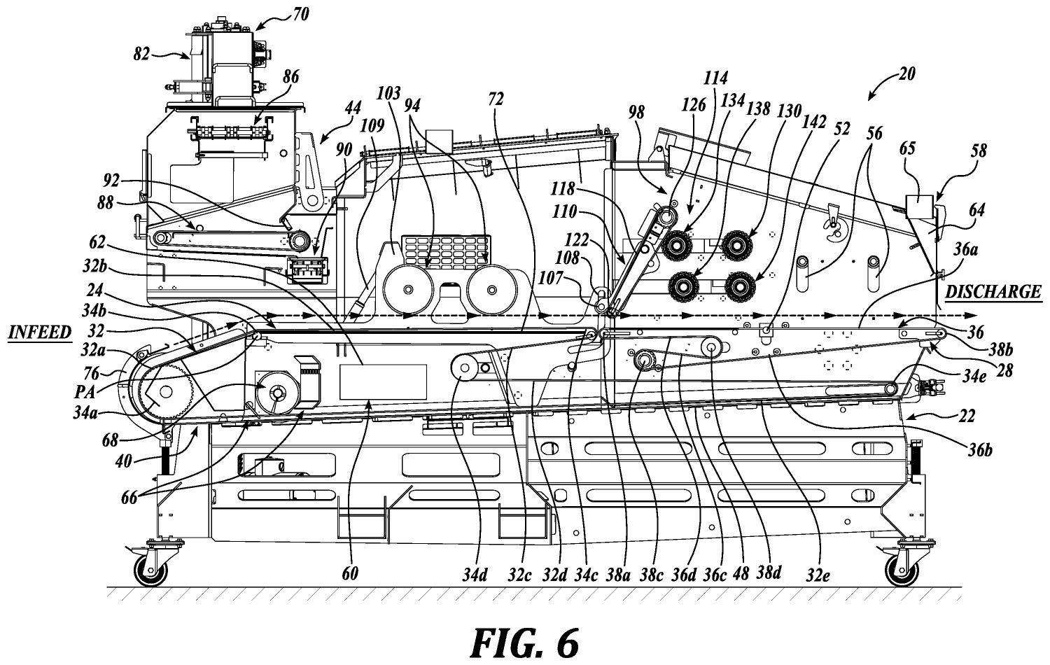

The feed conveyor 110 is moveable between first and second feed configurations to facilitate positioning of the feed conveyor 110 relative to the second upper belt run 32b of the upstream conveyor system 24. More specifically, the feed conveyor 110 is moveable between a first, non-feed configuration, where the upstream end of the feed conveyor 110 is lowered to a non-operational height (see FIG. 6) to allow movement of the second upper belt run 32b of the upstream conveyor system 24 into the lifted, second configuration, and a second, feed configuration, where the upstream end of the feed conveyor 110 is raised to its operational height (see FIG. 10A) to receive coated food products from the second upper belt run 32b of the upstream conveyor system 24 when it is in the lifted, second configuration.

The feed conveyor 110 may be moveable between the first and second feed configurations in any suitable manner. For instance, the feed conveyor 110 may be moveably secured to the upstream conveyor system 24 such that the feed conveyor 110 moves between the first and second non-feed and feed configurations when the upstream conveyor system 24 is moved between the first and second substantially horizontal and lifted configurations. In that manner, the first and second linear actuators 104 and 109 may be used to simultaneously move the upstream conveyor system 24 and the feed conveyor 110.

In the depicted example, the upstream end of the feed conveyor 110 may be moveably secured to the first and second conveyor assembly brackets 102 and 103 of the upstream conveyor system 24 such that the upstream end of the feed conveyor 110 moves with the upstream conveyor system 24 between the first and second configurations. For instance, each side of the feed conveyor 110 may be secured to first and second transfer roller brackets 105 and 106. A downstream end of each of the first and second transfer roller brackets 105 and 106 may be pivotably secured to the coating apparatus frame 22, such as through the second transfer roller 126 of the feed conveyor 110. In that regard, a shaft of the second transfer roller 126 may pass through the downstream end of each of the first and second transfer roller brackets 105 and 106 such that the second transfer roller 126 may be pivotably secured to the frame 22. The first transfer roller 122 of the feed conveyor 110 may be pivotally secured to an upstream end of the first and second transfer roller brackets 105 and 106.

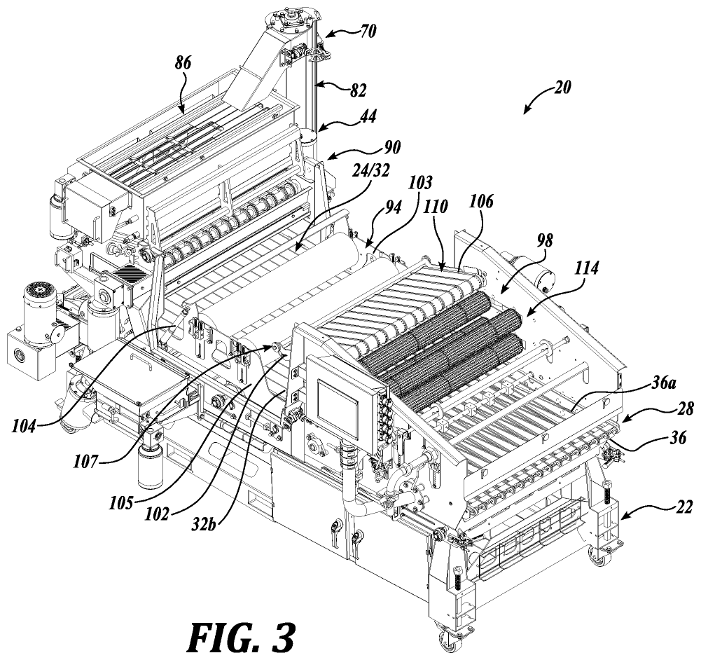

A roller bearing assembly 107 at an upstream end of each of the first and second transfer roller brackets 105 and 106 may be moveably secured within a slot 108 defined in the first and second conveyor assembly brackets 102 and 103 (see FIGS. 6, 7, and 10A, showing the roller bearing assembly 107 secured in the slot 108 of the first and second conveyor assembly brackets 102 and 103, whereas FIG. 3 shows the roller bearing assembly 107 separated from the first and second conveyor assembly brackets 102 and 103 to show aspects of the roller bearing assembly 107). The roller bearing assembly 107 may move along the path defined by the slot to accommodate movement of the feed conveyor 110 relative to the upstream conveyor system 24. More specifically, the roller bearing assembly 107 moves within the elongated slot 108 to accommodate movement of the upstream conveyor system 24 about pivot axis PA. The feed conveyor 110 may instead be moveable between the first and second non-feed and feed configurations in any other suitable manner, such as manually, automatically or semi-automatically with a separate actuator, etc.

In the second feed configuration, the feed conveyor 110 may be angled upwardly from its upstream end to its downstream end. In the example shown, the angle of the feed conveyor 110 is substantially the same as the angle of the second upper belt run 32b when the upstream conveyor system 24 is in the second, raised configuration. In that regard, the feed conveyor 110 may be at an angle relative to horizontal that is about 20 degrees.

With the feed conveyor 110 angled upwardly from its upstream end to its downstream end, the feed conveyor 110 may continue to move food products upwardly after receipt from the second upper belt run 32b of the upstream conveyor system 24. By angling the feed conveyor 110 upwardly in its second, feed configuration, the feed conveyor 110 can place the coated food products in a suitably high vertical position for depositing into the selective compression subassembly 114 without the need to raise the second upper belt run 32b of the upstream conveyor system 24 into a higher, raised configuration.

Exemplary aspects of the selective compression subassembly 114 will now be described. The selective compression subassembly 114 is generally configured to impart a home style texture or another desired texture to the coated food products as the coated food products pass therethrough. In the example shown, the selective compression subassembly 114 is configured as a plurality of rotating cylindrical wheels having elongated axes extending substantially transversely to the longitudinal axis of the conveyor systems.

The rotating cylindrical wheels each have a length that is substantially the same as the width of the upstream and downstream conveyor systems 24 and 28 and the feed conveyor 110. In other words, the rotating cylindrical wheels substantially span the full width of the conveyor belts to treat the food products without significantly altering food product belt coverage. In this manner, throughput of coated food products is not limited or restricted by the selective compression subassembly 114. In other words, the coated food product spread across the width of the feed conveyor 110 remains substantially unchanged or spread out across the width of the rotating cylindrical wheels as they pass through the selective compression subassembly 114.

The selective compression subassembly 114 may include any suitable number of rotating cylindrical wheels for creating a home style texture or another desired texture for a desired food product, such as at least two rotating cylindrical wheels. The number of rotating cylindrical wheels may depend, for instance, on the size, shape, composition, muscle structure, etc., of the food product, the type of coating used, the desired texture of the coating, etc. In the example shown, the selective compression subassembly 114 includes first, second, third, and fourth rotating cylindrical wheels 130, 134, 138, and 142, which may be a suitable number for texturizing a food product such as chicken breasts, chicken drum sticks, chicken thighs, or the like. Fewer than four rotating cylindrical wheels may provide insufficient texture, whereas more than four rotating cylindrical wheels may cause coating to detach from the substrate of the food product.

Each of the first, second, third, and fourth rotating cylindrical wheels 130, 134, 138, and 142 also has an exterior geometry or outer surface contour suitable to apply a selective compression to coated food products as the products engage the wheels with a predetermined amount of force. In some examples, each of the first, second, third, and fourth rotating cylindrical wheels 130, 134, 138, and 142 has a substantially identical exterior geometry. However, in other examples, the exterior geometry of one or more of the first, second, third, and fourth rotating cylindrical wheels 130, 134, 138, and 142 may differ. For instance, one of more of the wheel geometries may be different to enable desired textural attributes to be accentuated to meet specific needs related to the food product muscle structures. In any event, the exterior geometry of each of the first, second, third, and fourth rotating cylindrical wheels 130, 134, 138, and 142 is generally configured to produce surface indentations in the coated food product as the food product is compressed against the respective wheel for optimizing at least one of food product texture, hydration, and coating pick-up.

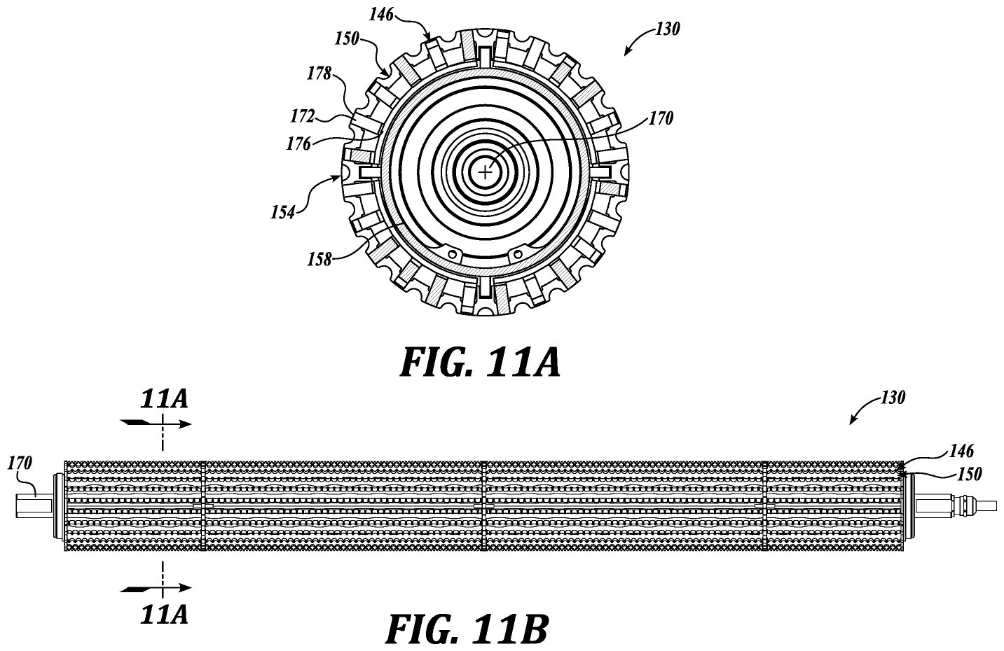

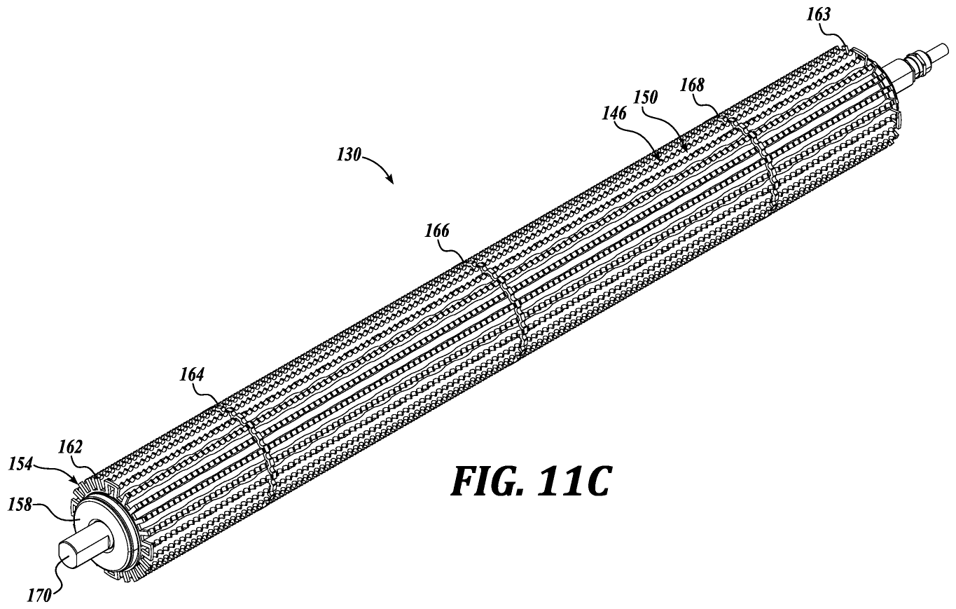

An exemplary exterior geometry of the first, second, third, and fourth rotating cylindrical wheels 130, 134, 138, and 142 (hereinafter sometimes simply “cylindrical wheel exterior geometry”) will be described with reference to the first rotating cylindrical wheel 130 shown in FIGS. 11A-11C. In the depicted example, the cylindrical wheel exterior geometry is defined by a plurality of elongated protrusions 146 separated by elongated valleys 150, each extending axially along the length of the cylindrical wheel.

The elongated protrusions 146 and the elongated valleys 150 may be defined within a removable outer cylindrical shell 154 securable onto a cylindrical wheel core 158 rotatable by a drive rod 170. The removable outer cylindrical shell 154 may be interchangeable with other outer cylindrical shell designs to accommodate different types of food products, coating, and desired texture. Moreover, it can be appreciated that by using a removable outer cylindrical shell rather than a wheel of unitary contraction, ease of manufacturability of the wheel is optimized. With that in mind, the wheels may instead be of unitary construction or constructed in any other suitable manner.

The outer cylindrical shell 154 and/or the cylindrical wheel core 158 may be divided along the longitudinal axis of the wheel 130 into two or more sections for ease of manufacturability, assembly, modification, etc. A suitable end piece 162 and 163 substantially similar in cross-sectional shape to the outer cylindrical shell 154 may be secured to the cylindrical wheel core 158 at each end of the wheel to retain the outer cylindrical shell 154 thereon and/or provide other support. Moreover, first, second, and third intermediate pieces 164, 166, and 168 substantially similar in cross-sectional shape to the outer cylindrical shell 154 may be secured on the cylindrical wheel core 158 in between any sections of outer cylindrical shell 154 and/or to secure together separate wheel pieces to define a wheel having a length that substantially spans the full width of the conveyor belts.

Each of the plurality of elongated protrusions 146 may be substantially identical in shape and size, and each of the elongated valleys 150 may be substantially identical in shape and size. In that regard, a repeating pattern of protrusions 146 and elongated valleys 150 may extend circumferentially around the outer surface of each outer cylindrical shell 154.

Each of the elongated protrusions 146 may be defined by a rectangular body 172 extending radially from the cylindrical wheel core 158. A first shortened end 176 of the rectangular body 172 extends along the outer surface of the cylindrical wheel core 158, and a second shortened end 178 of the rectangular body 172 defines the outer surface of the protrusions 146. In some examples, such as in the depicted embodiment, the second shortened end 178 includes a U-shaped scalloped contour along its length (i.e., along the longitudinal axis of the wheel 130). The scalloped contour is defined by a repeating pattern of peaks and valleys. In that regard, the first wheel 130 includes a peak/valley contour extending along the longitudinal axis of the wheel 130 as well as circumferentially about the outer surface of the wheel 130. In other examples, the second shortened end 178 of the rectangular body 172 may be substantially flat along its length. The geometry of the wheels (e.g., the radial peak/valley contour together with the optional axial peak/valley contour) helps produce home style texture or another desired texture for the coated food products by producing surface indentations in the coated food products, tenderizing muscle structure of the substrate, compressing a coating layer(s) on the food product, etc., when the food products engage the wheels by a compressive force.

The compressive force is generated by subjecting each of the coated food products to a suitably high velocity as they are gravitationally fed into the selective compression subassembly 114 and as they continue to travel along the linear, gravity-fed path of the selective compression subassembly 114. The compressive force is dependent, at least in part, on the trajectory of the food product as it enters the selective compression subassembly 114. Trajectory of a food product may be defined by the feed velocity, or the speed of the food product as it leaves the feed conveyor 110, the angle of approach, or the angle of the food product when it leaves the feed conveyor 110, and the initial height of the food product, or its height in relation to an imaginary horizontal plane that is tangential to the outer nominal circumference of the wheel that will be first engaged. Each of the feed velocity, angle of approach, and initial height may be adjusted to accommodate food products of different sizes, muscle structure, desired coating texture, etc.

Regarding the feed velocity, the speed of the feed conveyor 110, or the speed at which the endless conveyor belt 118 travels around the first and second transfer rollers 122 and 126, may be increased or decreased to adjust the trajectory of the coated food products as they leave the feed conveyor 110. As can be appreciated by one of ordinary skill, increasing the speed of the feed conveyor 110 will increase the horizontal velocity component of the product's trajectory. Increasing the trajectory may be desired for larger food products and/or when a higher compressive force is needed.

Regarding the angle of approach, the upward angle of the feed conveyor 110 (or its angle relative to horizontal) may also be adjusted as necessary to increase or decrease the trajectory of the coated food products as they leave the feed conveyor 110. As can be appreciated by one of ordinary skill, increasing the angle of the feed conveyor 110 relative to horizontal will increase the vertical velocity component of the product's trajectory.

Regarding the initial height, the coated food products are introduced into the selective compression subassembly 114 at a location or point of feed vertically above an imaginary horizontal plane that is tangential to the outer nominal circumference of the first wheel engaged (in this example, the first rotating cylindrical wheel 130) such that the coated food products hit the first wheel with a suitable gravitational force. In that regard, the discharge end of the feed conveyor 110 (i.e., at the second transfer roller 126) may be located a suitable distance above the imaginary horizontal plane that is tangential to the outer nominal circumference of the first rotating cylindrical wheel 130 to allow the coated food product to fall a suitable distance before engaging the first wheel 130. The feed conveyor 110 may be adjustable in height relative to the selective compression subassembly 114, and specifically in this example, the first rotating cylindrical wheel 130, to adjust the falling distance. In other examines, the wheels of the subassembly 114 are adjustable in location relative to the feed conveyor 110.

In other aspects, one or more other parameters of the selective compression subassembly 114 may be adjusted to achieve a desired compressive force. For instance, one or more of the spacing, position, and speed of the wheels (e.g., the first, second, third, and fourth rotating cylindrical wheels 130, 134, 138, and 142) may be adjusted to achieve a desired compressive force.

An exemplary arrangement of the first, second, third, and fourth rotating cylindrical wheels 130, 134, 138, and 142, including their spacing and positioning, will first be described with reference to FIG. 10B. Generally, the wheels are suitably positioned relative to the discharge end of the feed conveyor 110 and spaced relative to each other to apply a selective yet random compression force to the coated food products as they pass through the selective compression subassembly 114. Each of the wheels rotate either clockwise or counterclockwise in the direction of product flow.

In some examples, the first, second, third, and fourth rotating cylindrical wheels 130, 134, 138, and 142 are arranged such that a food product engages each wheel at least once as it descends through the selective compression subassembly 114. For instance, the wheels of the selective compression subassembly 114 may be arranged such that a coated food product hits the first rotating cylindrical wheel 130, then it hits the second rotating cylindrical wheel 134, then it again hits the first rotating cylindrical wheel 130, then it hits the third rotating cylindrical wheel 138, and finally it hits the fourth rotating cylindrical wheel 142 before landing on the upper belt run 36a of the downstream conveyor belt 36.

In the depicted exemplary embodiment, which may be configured for a product like chicken breasts, chicken drumsticks, chicken thighs, or the like, the first rotating cylindrical wheel 130 is located vertically below and spaced horizontally downstream from the discharge end of the feed conveyor 110. The second rotating cylindrical wheel 134 is spaced parallelly upstream from the first wheel 130 along substantially the same horizontal plane. In other words, the first and second wheels 130 and 134 have substantially vertically parallel longitudinal axes. The third and fourth rotating cylindrical wheels 138 and 143 similarly have substantially vertically parallel longitudinal axes, but they are located vertically below the first and second rotating cylindrical wheels 130 and 134. Further, the horizontal location of the third and fourth rotating cylindrical wheels 138 and 143 is slightly staggered or offset from the horizontal location of the second and first rotating cylindrical wheels 134 and 130, biased in the direction of product flow. Specifically, the third and fourth rotating cylindrical wheels 138 and 143 are located horizontally downstream from the second and first rotating cylindrical wheels 134 and 130, respectively. Such staggering helps improve rotational alignment for selective compression of the coated food product through a second passthrough of the selective compression subassembly 114 following a first passthrough through the first and second rotating cylindrical wheels 130 and 134.

With the rotating cylindrical wheels 138 and 143 arranged in the manner described and shown, a coated food product follows a generally zig-zag, back and forth, reversed S-Curve path of travel as it descends through the selective compression subassembly 114. Arrows H1-H6 depict an exemplary back and forth path of travel of a food product as it descends through the selective compression subassembly 114. The travel path of the food product through the selective compression subassembly 114 is preceded by an exemplary trajectory path of a food product depicted by arrows T1-T3.

Detailed aspects of the exemplary wheel arrangement of the selective compression subassembly 114 to support such a travel path will now be described. The first rotating cylindrical wheel 130 is located vertically below and spaced horizontally downstream from the discharge end of the feed conveyor 110. The first rotating cylindrical wheel 130 is positioned to intercept a trajectory path of a food product leaving the discharge end of the feed conveyor 110. Specifically, a food product hits an upper, upstream portion of the outer surface of the first rotating cylindrical wheel 130. An upper, upstream portion of the first rotating cylindrical wheel 130 may be considered to be an upper half of the wheel that faces upstream toward the feed conveyor 110. An arrow H1 represents a food product hitting an upper, upstream facing portion of the outer surface of the first rotating cylindrical wheel 130.

The food product hits the upper, upstream portion of the outer surface of the first rotating cylindrical wheel 130 with a predetermined compressive force, as determined by the trajectory of the food product. The compressive force creates surface indentations in the food product and/or coating, tenderization of the food product, etc., as will be discussed in further detail below. As noted above, at least one of the feed velocity, angle of approach, and initial height may be adjusted to change the trajectory and therefore the compressive force when hitting the first rotating cylindrical wheel 130, such as to accommodate food products of different sizes, muscle structure, desired coating texture, etc.

The first rotating cylindrical wheel 130 is rotating when the food product hits the first wheel 130. More specifically, the first rotating cylindrical wheel 130 is rotating counterclockwise about its center longitudinal axis (defined by the drive rod 170) at a predetermined speed. Thus, when the food product hits the upper, upstream facing portion of the outer surface of the first rotating cylindrical wheel 130 (e.g., at arrow H1), the first wheel 130 imposes a tangential force on the food product. The tangential force imposed by the first rotating cylindrical wheel 130 is generally along a tangent line directed upstream at a downward angle, such as along the line extending between arrows H1 and H2. In that regard, the tangential force imposed by the first rotating cylindrical wheel 130 causes the food product to move along an upstream and downward trajectory toward the second rotating cylindrical wheel 134. The food product hits the second rotating cylindrical wheel 134 near a center, downstream portion of the second wheel 134, which is generally represented by arrow H2.

As noted above, the second rotating cylindrical wheel 134 is in substantial vertical alignment with the first rotating cylindrical wheel 130 but spaced parallelly upstream from the first wheel 130 along substantially the same horizontal plane. More specifically, the center longitudinal axis of the second rotating cylindrical wheel 134 is substantially vertically parallel to the center longitudinal axis of the first rotating cylindrical wheel 130. However, the second rotating cylindrical wheel 134 is spaced upstream from the first rotating cylindrical wheel 130 such that a gap is defined between the first and second wheels 130 and 134.

The second rotating cylindrical wheel 134 is rotating when the food product hits the second wheel 134. More specifically, the second rotating cylindrical wheel 134 is rotating clockwise about its center longitudinal axis (defined by the drive rod 170) at a predetermined speed. Thus, when the food product hits the center, downstream portion of the second rotating cylindrical wheel 134 (e.g., at arrow H2), the second wheel 134 imposes a tangential force on the food product. The tangential force imposed by the second rotating cylindrical wheel 134 is generally along a tangent line directed downstream at a downward angle, such as along the line extending between arrows H2 and H3. In that regard, the tangential force imposed by the second rotating cylindrical wheel 134 causes the food product to move along a downstream, downward trajectory toward first rotating cylindrical wheel 130. The food product hits the first rotating cylindrical wheel 130 in a lower, downstream portion of the first rotating cylindrical wheel 130, which is generally represented by arrow H3.

The counterclockwise rotation of the first rotating cylindrical wheel 130 imposes a tangential force on the food product generally along a tangent line directed upstream at a downward angle, such as along the line extending between arrows H3 and H4. In that regard, the tangential force imposed by the first rotating cylindrical wheel 130 causes the food product to move along an upstream and downward trajectory toward the third rotating cylindrical wheel 138.

As noted above, the third rotating cylindrical wheel 138 is located vertically below the first and second wheels 130 and 134. Moreover, the third rotating cylindrical wheel 138 is at a horizontal location that is downstream from the second rotating cylindrical wheel 134. At the same time, the third rotating cylindrical wheel 138 is located horizontally upstream from the first rotating cylindrical wheel 130. For instance, an imaginary vertical tangent plane extending along an outer surface of the third rotating cylindrical wheel 138 extends along a horizontal location that is about halfway between the first rotating cylindrical wheel 130 and second rotating cylindrical wheel 134. In this manner, the food product hits the third rotating cylindrical wheel 138 in an upper, downstream portion of the third wheel 138, which is generally represented by arrow H4.

The third rotating cylindrical wheel 138 is rotating when the food product hits the third wheel 138. More specifically, the third rotating cylindrical wheel 138 is rotating clockwise about its center longitudinal axis (defined by the drive rod 170) at a predetermined speed. Thus, when the food product hits the upper, downstream portion of the third rotating cylindrical wheel 138 (e.g., at arrow H4), the third wheel 138 imposes a tangential force on the food product. The tangential force imposed by the third rotating cylindrical wheel 138 is generally along a tangent line directed downstream at a downward angle, such as along the line extending between arrows H4 and H5. In that regard, the tangential force imposed by the third rotating cylindrical wheel 138 causes the food product to move along a downstream, downward trajectory toward fourth rotating cylindrical wheel 142. The food product hits the fourth rotating cylindrical wheel 142 in about a center, upstream portion of the fourth rotating cylindrical wheel 142, which is generally represented by arrow H5.

As noted above, the fourth rotating cylindrical wheel 142 is located vertically below the first and second wheels 130 and 134. Moreover, the fourth rotating cylindrical wheel 142 is at a horizontal location that is downstream from the first rotating cylindrical wheel 30. The fourth rotating cylindrical wheel 142 is located horizontally relative to the first and second rotating cylindrical wheels 130 and 134 such that the food product hits the fourth rotating cylindrical wheel 142 in about a center, upstream portion of the fourth wheel 142 (e.g., at arrow H5).

The fourth rotating cylindrical wheel 142 is rotating when the food product hits the fourth wheel 142. More specifically, the fourth rotating cylindrical wheel 142 is rotating counterclockwise about its center longitudinal axis (defined by the drive rod 170) at a predetermined speed. Thus, when the food product hits a center, upstream portion of the fourth wheel 142 (e.g., at arrow H5), the fourth wheel 142 imposes a tangential force on the food product. The tangential force imposed by the fourth rotating cylindrical wheel 142 is generally along a tangent line directed downstream at a downward angle, such as along the line extending between arrows H5 and H6. In that regard, the tangential force imposed by the fourth rotating cylindrical wheel 142 causes the food product to move along an upstream, downward trajectory toward the downstream conveyor system 28. As the food product continues to fall, its trajectory may become more vertical, and the food product drops onto the upper belt run 36a of the downstream conveyor belt 36. The food products are conveyed by the downstream conveyor belt 36 past the one or more vibration assemblies 52 and the one or more blower assemblies 56 and are eventually discharged from the coating apparatus 20.

As the coated food products pass through the selective compression subassembly 114 and engage each of the rotating cylindrical wheels, such as in the manner described above, a home style texture or effect may be defined in the coating. More specifically, engaging each of the rotating cylindrical wheels with direct and forceful contact while minimizing product-to-product contact, such as in the manner described above, results in rapid selective yet random compression of the coating and the substrate of the food product. The rapid selective yet random compression of the coating produces surface indentations in the coating both selectively and randomly as a function of time.

In some aspects, the rotating cylindrical wheels can be understood to perform the action of human hands used in hand kneading and tossing. As noted above, a home style appearance is often achieved at home with a combination of hand kneading and tossing. In that regard, the food product may be “kneaded” when engaging a wheel, with the protrusions 146 and valleys 150 of each wheel simulating fingers of a hand. The food products may be “tossed” between the wheels as the product is moved back and forth between the wheels by the tangential force of the wheels. Such an effect can be understood to be similar to the action of a food product being shaken and tossed by hand, only at an accelerated rate.

The forceful contact with the rotating cylindrical wheels can cause the coating to take on a textured or “home style” appearance. As the coated food product engages the wheels, the protrusions 146 and valleys 150 of each wheel can push the batter and coating around on the surface of the food product, creating coating ridges, valleys, peaks, balls, and other irregular surface indentations.

The surface indentations of the coating also produce hydration. During a coating process, it is important to build up the coating to allow the batter(s) and the coating(s) to have time to properly hydrate and to “attach” itself to the food product. If a heavy coating is added too quickly, the coating will not properly adhere and will fall off during frying, handling, or freezing, resulting in uncoated product. Compression or indentation of the coating actuates the coatings to hydrate into and through the inner batter layer surrounding the substrate. Hydration is extracted to the outer surface of the coating, allowing additional coating to attach and further increase pick up.

The surface indentations, combined with residual hydration, provide a foundation for causing texture by facilitating the continuous pushing of batter and breading around with the protrusions 146 and valleys 150 of each wheel. In that regard, hydration may occur substantially concurrently with texture production, collectively and cooperatively contributing to a final “home style” textural appearance.

The rapid selective compression also produces surface indentations in the substrate of the food product and enhances the coating process by opening up the substrate both selectively and randomly as a function of time as it descends through the selective compression subassembly 114. For instance, the substrate is compressed more at areas that engage the protrusions 146 of each wheel in relation to the areas of the substrate that engage the elongated valleys 150 of the wheel. In other words, there is higher compression of the substrate at the protrusions 146. Such compression differences in the substrate helps tenderize the muscle structure of the substrate.

The compression differences imposed by the protrusions 146 and elongated valleys 150 of each wheel also produce surface indentations in the substrate, which enhance the home style appearance of the coating and increase hydration. The protrusions 146 and elongated valleys 150 of each wheel creates corresponding peaks and valley contours on the surface of the substrate. The valleys in the substrate correspond to points of higher compression, which can give rise to greater amounts of instantaneous hydration of a substrate surface. As noted above, hydration allows the food product to soak in more coating for higher pick up from the incoming coating passage (e.g., from the top and bottom layer coating assemblies 40 and 44).

The compression differences in the substrate resulting from the first passthrough of the selective compression subassembly 114 (e.g., through the first and second rotating cylindrical wheels 130 and 134) helps prepare the coating foundation for more hydration, pickup, and texturizing during the second passthrough or finishing step (e.g., through the third and fourth rotating cylindrical wheels 138 and 142). The higher compression contact points of the second passthrough may be more random due to the vertical separation and gravity fall of the food products as they descend through the selective compression subassembly 114.

When engaging a rotating cylindrical wheel at a high tangential velocity, the substrate at least somewhat conforms to the arced shape of the outer surface of the rotating cylindrical wheel. Phrased another way, a substantially flat food product may be transformed into an arced shape when it hits a wheel. When the food product transforms into an arced configuration, the coating layer may break open. Moreover, the food product substrate may open up, allowing access to crevices in the substrate, areas beneath folds, etc. Excess coating material falling through the selective compression subassembly 114 can fall into, bind to, or otherwise be received within such breaks or openings in the coating/substrate, increasing coating pickup and enhancing coating texture.

In prior art rotary drum breaders, the food products entering the drum are typically coated to a base level; however, hydration predominantly occurs within the rotating drum through rolling and tumbling action of the food products. Developing a home style texture requires a substantial amount of product-to-surface as well as product-to-product interaction in the drum. Long residence times in the drum are therefore often needed to develop the home style texture. Moreover, the product exits the drum in piles on to a takeaway conveyor, and further time is needed to spread the food products evenly across the belt width.

Using the systems and methods disclosed herein, the food products are well hydrated and pick-up occurs at a very fast rate, resulting in significantly less required dwell time. Hydration and pickup occurs on a piece-by-piece basis, or through individual product-to-wheel surface contact as well as limited product-to-product contact, as opposed to a collective and more random hydration/pick-up and/or losses occurring within a drum. Coated food product contact with the rotating wheels of a defined surface geometry during the first and second passthroughs in the selective compression subassembly 114 causes incremental and instantaneous hydration. The piece-by-piece, incremental hydration occurring in the selective compression subassembly 114 is more efficient than the collective hydration effects in a drum. Such a higher rate of hydration increases the amount of pick up as a function of time.

As can be appreciated, using a coating apparatus in accordance with the systems and methods disclosed herein allows for hydration, pickup and texture to occur at substantially the same time. This substantially concurrent hydration, pickup and texture substantially reduces the time of engagement for a food product to achieve a “home style” appearance.

Moreover, the food products remain substantially spread out across the width of the belt during the hydration/pick-up process, minimizing product-to-product contact and therefore maximizing product-to-wheel surface contact. In that regard, the systems and methods disclosed herein can be used to replace the rolling and tumbling action of a drum breader with a high-speed tangential, product-to-surface compression action while aligning the axis of rotation of the necessary rotational elements (e.g., the rotating cylindrical wheels) perpendicular to the product travel path. This perpendicular orientation of the wheels, allowing product spread and avoiding product pile up, in combination with the short time of engagement, produces substantially higher throughput compared to a rotary drum breader.

The two-phase treatment system and method described herein (e.g., using the first and second passthroughs of the selective compression subassembly 114 of the coating apparatus 20) is accomplished in a very short amount of time, making the time of engagement required to develop home style textural attributes of a food product substantially shorter than prior art linear applicators and rotary drums. The inventors have found that up to a 400% greater throughput on all types of food products can be achieved using the present systems and methods. Moreover, this increased throughput is achieved without sacrificing product quality.

An example regarding dwell time for the selective compression subassembly 114 will hereinafter be provided to illustrate this concept. Dwell time may be calculated based on the tangential velocity at which the food product travels through the selective compression subassembly 114. The time of engagement is equal to the food product length of travel divided by the tangential velocity of the food product. The tangential velocity of the food product is based on the speeds of the rotating cylindrical wheels 130, 134, 138, and 142. Here, the calculations were based on 4 inch diameter rotating cylindrical wheels having speeds of 200-350 RPMs.

Based on empirical evidence, the average time of engagement for such the selective compression subassembly 114 would be between 0.16-28 seconds. By comparison, the average time of engagement for a conventional drum breader is about 5.92 seconds (over 26 times longer), and the average time of engagement for a linear home style breader is about 9.3 seconds (39 times longer). The production rate equivalency of the selective compression subassembly 114, or the time of engagement/piece, is about 1.76, wherein the production rate equivalency of a conventional drum breader is 5.92, and the production rate equivalency of a linear home style breader is 8.60. In that regard, using a coating apparatus in accordance with the systems and methods disclosed herein can produce a significantly lower cost per pound of product delivered compared to prior art systems, yet with the same or better quality.

In the examples described herein, the rotating cylindrical wheels 130, 134, 138, and 142 may rotate at substantially the same speed (RPM) and in unison. Generally, the rotational speeds of the of the spaced apart cylindrical wheels are designed to coact in unison to produce a desired surface texture of a food product consisting of varying muscle structure and/or size. However, in some examples, one or more of the rotating cylindrical wheels 130, 134, 138, and 142 may rotate at a different speed to accommodate different food product sizes, different muscle structures, desired texture, etc. Moreover, if the speed of one or more of the rotating cylindrical wheels 130, 134, 138, and 142 is increased or decreased, one or more of the spacing between the wheels (e.g., horizontal spacing, vertical spacing, and/or stagger between the first and second passthroughs) and the trajectory of the food product fed into the selective compression subassembly 114 may also be changed to accommodate different food product sizes, different muscle structures, desired texture, etc.

In any event, the speed of one or more of the rotating cylindrical wheels 130, 134, 138, and 142 may be sufficiently high to cause the food product to effectively bounce back and forth between the wheels without shredding or otherwise damaging the substrate of the food product. Moreover, the speed of one or more of the rotating cylindrical wheels 130, 134, 138, and 142 may be sufficiently high to help prevent coating buildup within the machine. For instance, the speed of one or more of the rotating cylindrical wheels 130, 134, 138, and 142 may be about 200-350 RPMs.

As noted above a coating apparatus formed in accordance with the systems and methods disclosed herein (e.g., coating apparatus 20) can be used to produce a “home style” coating that is of the same or better quality than a traditional rotary drum breader. However, defining a “home style” texture for a given food product is somewhat subjective. In comparative studies, people are often able to say that one texture is better than another in a side-by-side evaluation of the same type of food products coated using two differing technologies. Describing the visual acuity of a desired texture in the absence of a such side-by-side comparison is difficult. Therefore, it would be beneficial to increase the objectivity, predictiveness, automation, control, etc., of a home style coating or another texturizing process, such as using the coating apparatus 20 described herein.

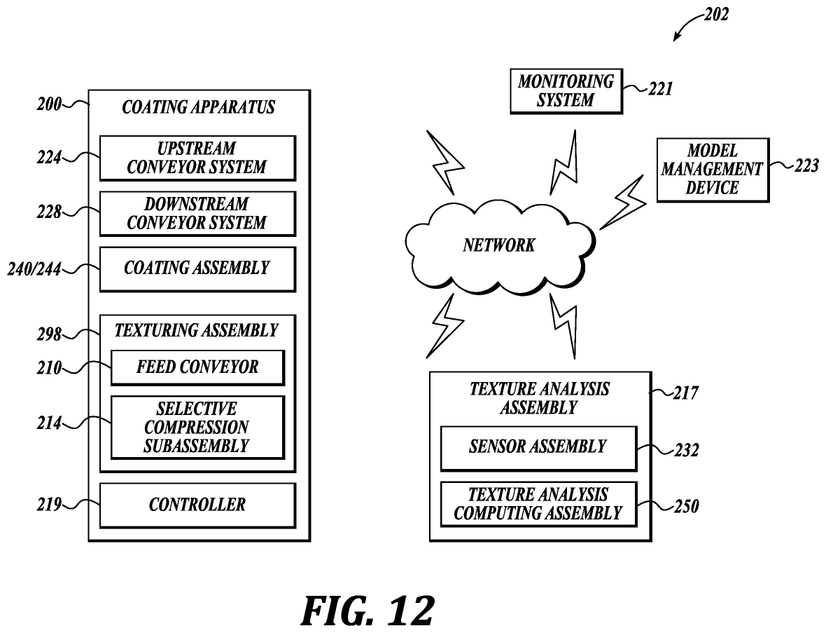

FIG. 12 depicts a schematic illustration of a non-limiting example of a food product texture management system 202 that can be used to assess a texture of a food product coated with a coating apparatus and provide at least one of recommendations for coating apparatus adjustment, instructions to a controller of the coating apparatus for adjustment, or the like, for tracking and/or causing a change in the texture of a food product coated with the coating apparatus. The food product texture management system 202 may include various networked computing devices configured for carrying out aspects of gathering and processing texture data for assessing one or more attributes of the texture sample, as well as other aspects of processing food product coated with the coating apparatus (e.g., conveying, frying, cooking, cooling, sorting, packaging, etc.).

In the depicted example, the food product texture management system 202 includes a coating apparatus 200, a texture analysis assembly 217, a monitoring system 221, and a model management computing device 223 communicatively coupled together through a network. The network can be any kind of network capable of enabling communication between the various components of the food product texture management system 202. For example, the network can be a WiFi network.

The coating apparatus 200 may be substantially similar to the coating apparatus 20 described herein. In that regard, like parts will be labeled with the same reference numeral, except in the '200 series. However, it should be appreciated that the food product texture management system 202 may instead be used with any other suitable coating apparatus.

The exemplary coating apparatus 200 includes an upstream conveyor system 224 moveable between a first, horizontal conventional configuration and a second, raised, home style configuration, as described above with respect to the coating apparatus 20. The coating apparatus 200 includes a coating assembly, such as a top layer coating assembly 240 and a bottom layer coating assembly 244 similar to the top and bottom layer coating assemblies 40 and 44 described above. The coating apparatus 200 further includes a downstream conveyor system 228 located beneath a texturizing assembly 298 having a feed conveyor 210 and a selective compression subassembly 214.

The feed conveyor 210 may include a feed conveyor adjustment assembly (not labeled) configured to adjust at least one of conveyor belt speed and angle of inclination for altering a trajectory of a food product leaving a discharge end of the feed conveyor 210. The selective compression subassembly 214 includes a plurality of rotating cylindrical wheels located vertically below and downstream from the feed conveyor 210, such as described above with reference to the coating apparatus 20. The rotating cylindrical wheels are adjustable in at least one of outer surface geometry, vertical spacing, stagger spacing between passthroughs, and speed (RPM). In that regard, the selective compression subassembly 214 may include a rotating cylindrical adjustment assembly (not labeled) configured to adjust at least one of an outer surface geometry, vertical spacing, stagger spacing between passthroughs, and speed (RPM) of a rotating cylindrical wheel(s).

The texture analysis assembly 217 is configured to assess a texture of a food product coated with the coating apparatus 200 and provide at least one of recommendations for coating apparatus adjustment, instructions to a controller 219 of the coating apparatus and/or the feed conveyor adjustment assembly and/or the rotating cylindrical adjustment assembly for adjusting one or more parameters of the coating apparatus 200, or the like, for tracking and/or causing a change in the texture of a food product coated with the coating apparatus. In that regard, the feed conveyor adjustment assembly and/or the rotating cylindrical adjustment assembly may be in communication with the controller 219 of the coating apparatus 200 and/or in communication with a computing device of the texture analysis assembly 217. The texture analysis assembly 217 may include any of the components and may use any of the processes described in International Patent Application No. PCT/US2024/012617incorporated by reference in its entirety.

In the depicted example, the texture analysis assembly 217 includes a sensor assembly 232 that is configured to generate sensor data regarding the texture of at least one food product that was coated with the coating apparatus 200. For instance, the sensor assembly 232 may include an image sensor assembly (for assessing a visual appearance of texture), a weight measurement assembly (for assessing pick-up), or another sensor assembly configured to capture data regarding the texture of a food product that was coated with the coating apparatus 200.

In some examples, the sensor assembly 232 includes one or more high resolution cameras for capturing still images of a coated food product. For instance, the sensor assembly 232 may include one or more optical still cameras, for example a greyscale camera, an RGB camera, an infrared (IR) and/or UV camera, a thermal imaging device, a thermal camera, a charge coupled device (CCD), a multispectral or hyperspectral camera, etc. An optical still camera can be used to acquire and/or generate one or more complete still images of the coated food product for detecting certain characteristics, such as, e.g., the outer contour of the food product.

The sensor assembly 232 may also or instead include image sensor technology suitable for capturing image data needed to generate a 3D model of the food product and/or a 2D representation of the height or elevation of the scene. In some examples, the image sensor assembly 132 includes at least one of a 3D vision system or a 3D laser scanning technology like LiDAR (Light Detection and Ranging), structured light scanning, or photogrammetry, a stereo depth camera, a Time-of-Flight (ToF) stereoscopic camera, or the like, or combinations thereof.

The image sensors may be located within or near the coating apparatus 200 for assessing food product texture after passing through the coating apparatus. For instance, the image sensors may be located near the discharge end of the downstream conveyor system 228 for assessing food product texture after passing through the coating apparatus 200. In addition or in the alternative, the image sensors may be located near a discharge end of a thermal processing system, such as after a fryer is used to thermally treat the coated food products. In this manner, food product texture may be assessed before and/or after frying, because frying or cooking can enhance the texture of the coating and/or give it its final appearance.

The sensor assembly 232 may include a light assembly configured to sufficiently illuminate the food product being captured by the sensor assembly 232. The sensor assembly 232 may further include an image processor, which may be used to receive, process, and package image data captured with the sensor assembly 232 for sending to a computing device of the food product texture management system 202. The sensor assembly 232 may include any other components necessary or suitable for the application and/or environment, such as a heater, shutters, a dust containment system, a conveyance system, etc.

The texture analysis assembly 217 further includes a texture analysis computing device 250 configured to process the sensor data to assess a texture of a food product coated with the coating apparatus 200 and provide at least one of recommendations for coating apparatus adjustment, instructions to the controller 219 and/or the feed conveyor adjustment assembly and/or the rotating cylindrical adjustment assembly for adjusting one or more parameters of the coating apparatus 200, etc., for tracking and/or causing a change in the texture of a food product coated with the coating apparatus.

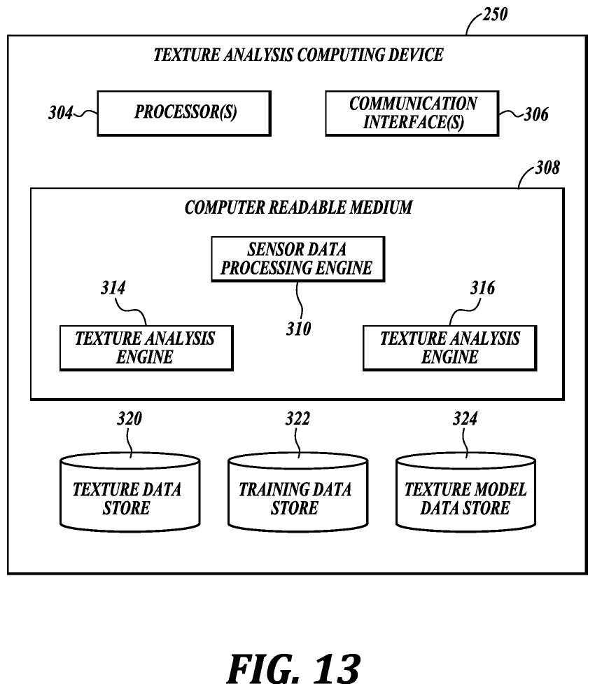

FIG. 13 depicts a block diagram that illustrates aspects of a non-limiting example of a texture analysis computing device 250 configured to carry out some or all of the functions of the texture analysis systems and method described herein. It should be appreciated that certain functions may instead be carried out by another computing device, such as the image processor of the sensor assembly 232, the controller 119, etc., and/or another computing device, such as the model management computing device 223 and/or the monitoring system 221. The texture analysis computing device 250 may be in networked communication with any of the other components of the texture analysis assembly 217, such as the sensor assembly 232 and/or an image processor of sensor assembly 232. Moreover, the texture analysis computing device 250 may be in communication with the feed conveyor adjustment assembly and/or the rotating cylindrical adjustment assembly.

In general, the texture analysis computing device 250 includes a processor(s) 304, a communication interface(s) 306, and computer readable medium 308, and one or more data stores (e.g., a texture data store 320, a training data store 322, and a texture model data store 324).

The texture analysis computing device 250 may be implemented by any computing device or collection of computing devices, including but not limited to a desktop computing device, a laptop computing device, a mobile computing device, an edge computing device, a PLC, a server computing device, a computing device of a cloud computing system, and/or combinations thereof. In some examples, the processor(s) 704 may include any suitable type of general-purpose computer processor. In some examples, the processor(s) 504 may include one or more special-purpose computer processors or AI accelerators optimized for specific computing tasks, including but not limited to graphical processing units (GPUs), vision processing units (VPTs), and tensor processing units (TPUs).

As shown, the computer readable medium 308 has stored thereon logic that, in response to execution by the one or more processor(s) 304, may cause the texture analysis computing device 250 to provide a sensor data processing engine 310, a texture analysis engine 314, and an apparatus adjustment engine 316.

In some examples, the communication interface(s) 306 includes one or more hardware and or software interfaces suitable for providing communication links between components. The communication interface(s) 306 may support one or more wired communication technologies (including but not limited to Ethernet, FireWire, and USB), one or more wireless communication technologies (including but not limited to Wi-Fi, WiMAX, Bluetooth, 2G, 3G, 4G, 5G, and LTE), and/or combinations thereof.

As used herein, “computer-readable medium” refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage.

As used herein, “engine” refers to logic embodied in hardware or software instructions, which can be written in one or more programming languages, including but not limited to C, C++, C#, COBOL, JAVA™, PHP, Perl, HTML, CSS, Javascript, VBScript, ASPX, Go, and Python. An engine may be compiled into executable programs or written in interpreted programming languages. Software engines may be callable from other engines or from themselves. Generally, the engines described herein refer to logical modules that can be merged with other engines or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

Exemplary aspects of the sensor data processing engine 310 will first be described. The sensor data processing engine 310 may be generally configured to process, format, store, and/or transmit any sensor data received and/or retrieved from the sensor assembly 232 and/or the image processor of the texture analysis assembly 217. The sensor data processing engine 310 may store the sensor data in a texture data store 320 for later retrieval, and/or transmit the sensor data to another device or engine (e.g., the texture analysis engine 314).

In one example, the sensor data processing engine 310 sends processed/formatted sensor data to the monitoring system 221, the model management computing device 223 or another computing device (e.g., a cloud-based computing device) in communication with the model management computing device 223. The sensor data may be used to train one or more machine learning models executable by the texture analysis computing device 250.

Exemplary aspects of the texture analysis engine 314 will now be described. The texture analysis engine 314 of the texture analysis computing device 250 may be generally configured to analyze the sensor data to assess a texture of a food product coated with the coating apparatus 200 (a “texture analysis”). A texture analysis may include comparing physical parameters/characteristics of the coated food product sample to a texture specification for that food product. A texture specification may include required values for physical parameters/characteristics. For instance, texture analysis may include comparing texture data taken from color images generated by the sensor assembly 232 (and/or the sensor data processing engine 310) to color specification images. For instance, a texture analysis module may run a feature recognition subroutine that is configured to match and/or compare texture features in each of the images.

The texture specification may be represented as reference data in tabular format, as a 3D model, as a drawing, a photo image, or as any other suitable format. The specification may be stored for instance, in the texture data store 320. The texture analysis engine 314 may retrieve relevant specification information stored in the texture data store 320 for running various modules configured to analyze various aspects of the texture.

In one aspect, the texture analysis engine 314 may run a specification module that may include comparing coated food product image data to texture specification information for the coated food product. Running the specification module may include identifying coordinates along an outer perimeter of a 2D or 3D model and comparing those coordinates to specifications of the coated food product for assessing the shape, size, etc., of the coated food product. If the image data sets match within a fixed threshold level, then the specification module may indicate that the coated food product conforms to the texture specification. If the image data sets do not match within a fixed threshold level, then the specification module may indicate that the coated food product is out of spec, and in some instances, how far out of spec (e.g., the percentage of texture non-conformance).

In some instances, the specification module may include using weight data (captured by a weight measurement assembly of the texture analysis assembly 217) to determine whether the weight of the coated food product falls within a required minimum or maximum threshold weight range (e.g., to determine pickup). If the weight of the coated food product is not within a required weight range, then the specification module may indicate that the coated food product is out of spec, and in some instances, how far out of spec (e.g., the percentage of weight difference).

If the desired texture of a coated food product is the “home style” appearance, the texture specification data may include data for a food product coated with a rotary drum breader. For example, the texture specification data may include images showing texture of a food product coated with a rotary drum breader, weight data indicating pickup for a food product coated with a rotary drum breader, etc. In that regard, food products coated with the coating apparatus 200 can be monitored to ensure a “home style” texture at least as good as a rotary drum breader.

If the texture analysis engine 314 indicates that the product is out of spec, the apparatus adjustment engine 316 may send instructions to the controller 119 and/or the feed conveyor adjustment assembly and/or the rotating cylindrical adjustment assembly for adjusting one or more parameters of the coating apparatus 200. For instance, the texture analysis engine 314 may send instructions to the feed conveyor adjustment assembly of the feed conveyor 210 to adjust at least one of conveyor belt speed and angle of inclination for altering a trajectory of a food product leaving a discharge end of the feed conveyor 210. The texture analysis engine 314 may also/instead send instructions to the rotating cylindrical adjustment assembly of the selective compression subassembly 214 to adjust at least one of outer surface geometry, vertical spacing, stagger spacing between passthroughs, and speed (RPM) of the rotating cylindrical wheels. In addition or in the alternative, the texture analysis engine 314 may output instructions or recommendations on a display, such as a display connected to the texture analysis computing device 250.

In some examples, the texture analysis engine 314 and/or the apparatus adjustment engine 316 carry out an iterative texture analysis and adjustment process. For instance, in response to a coated food product texture being out of spec as determined by the texture analysis engine 314, the apparatus adjustment engine 316 may output instructions to the controller 119 and/or the feed conveyor adjustment assembly and/or the rotating cylindrical adjustment assembly for adjusting one or more parameters of the coating apparatus 200. This process may be repeated as necessary until the coated food product texture is within specification. Such an iterative process may be used to validate a recipe-based control for the coated food product.

In some instances, data generated by the texture analysis engine 314 and/or the apparatus adjustment engine 316 may be used to train one or more machine learning models (e.g., stored in the texture model data store 324) to provide adjustments for the feed conveyor 210 and/or the selective compression subassembly 214 as output based on data analysis results of the texture analysis engine 314 and/or sensor data of the sensor assembly 232 as input.

In some examples, the texture analysis engine 314 may run one or more of the exemplary machine learning model(s) described in U.S. Provisional Patent No. 63/588,917 and International Patent Application No. PCT/US2024/012617, both incorporated herein in their entirety. Moreover, it should be appreciated that the machine learning models described herein are exemplary only, and other variations of the models described and/or additional models may also be used.

Any suitable type of machine learning models may be used, including but not limited to convolutional neural networks. Any suitable technique may be used to train the machine learning models, including but not limited to one or more of gradient descent, data augmentation, hyperparameter tuning, and freezing/unfreezing of model architecture layers. In some examples, annotated, raw images and in some instances, weight data are used as the training input. In some examples, one or more features derived from the images, including but not limited to versions of the images in a transformed color space, set of edges detected in the image, one or more statistical calculations regarding the overall content of the images, or other features derived from the images may be used instead of or in addition to the annotated raw images to train the machine learning models.

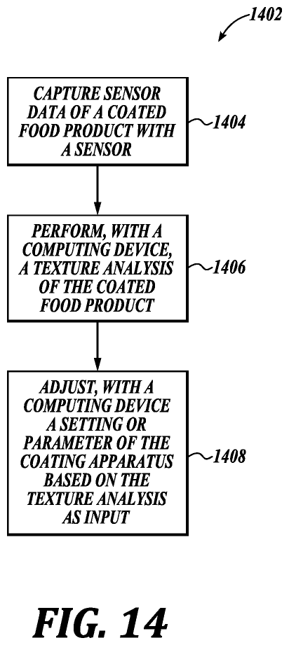

FIG. 14 is a flowchart that illustrates a non-limiting example of a method 1400 of performing a texture analysis for a coated food product, which may be carried out by one or more engines of the texture analysis computing device 250 or any other computing device. The method 1400 may be carried out for coated food products coated by the coating apparatus 200 optionally also after another process (e.g., frying).

At block 1404, the method 1400 may include capturing sensor data (e.g., one or more images) of a coated food product with a sensor assembly, such as with one or more high resolution cameras.

At block 1406, the method 1400 may include performing, with a computing device, a texture analysis of the coated food product, such as by comparing data points from the sensor data of the coated food product (e.g., a color image, a 2D or 3D model, a weight measurement, etc.) and a corresponding texture specification for the coated food product. For instance, the texture analysis engine 314 may run a specification module that may include comparing data of the models or other image data generated by the texture analysis engine 314 to texture specification information for the coated food product.

At block 1408, the method 1400 may further include adjusting, with a computing device (such as with the apparatus adjustment engine 316), a setting or parameter of the coating apparatus 200 based on the texture analysis as input. For instance, the apparatus adjustment engine 316 may send instructions to the controller 119 and/or the feed conveyor adjustment assembly and/or the rotating cylindrical adjustment assembly for adjusting one or more parameters of the coating apparatus 200 to adjust the end texture of the food product.

Although the example method 1400 described above depicts particular operations, the sequence and/or combinations of operations may be altered without departing from the scope of the present disclosure. For example, some of the operations described may be performed in parallel or in a different sequence that does not materially affect the function of the method 1400. In yet some examples, some of the operations described may be omitted. In other examples, different components of an example device or system may be used to implement the method 1400. The method 1400 may be carried out using any of the aspects disclosed herein.

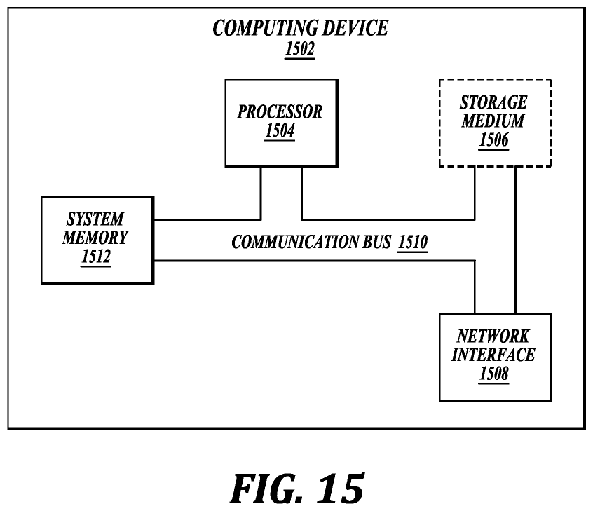

FIG. 15 is a block diagram that illustrates aspects of an exemplary computing device 1500 appropriate for use as a computing device of the present disclosure. While multiple different types of computing devices were discussed above, the exemplary computing device 1500 describes various elements that are common to many different types of computing devices. While FIG. 15 is described with reference to a computing device that is implemented as a device on a network, the description below is applicable to servers, personal computers, mobile phones, smart phones, tablet computers, embedded computing devices, and other devices that may be used to implement portions of examples of the present disclosure. Some examples of a computing device may be implemented in or may include an application-specific integrated circuit (ASIC), a field-programmable gate array (FPGA), or other customized device. Moreover, those of ordinary skill in the art and others will recognize that the computing device 1500 may be any one of any number of currently available or yet to be developed devices.

In its most basic configuration, the computing device 1500 includes at least one processor 1502 and a system memory 1510 connected by a communication bus 1508. Depending on the exact configuration and type of device, the system memory 1510 may be volatile or nonvolatile memory, such as read only memory (“ROM”), random access memory (“RAM”), EEPROM, flash memory, or similar memory technology. Those of ordinary skill in the art and others will recognize that system memory 1510 typically stores data and/or program modules that are immediately accessible to and/or currently being operated on by the processor 1502. In this regard, the processor 1502 may serve as a computational center of the computing device 1500 by supporting the execution of instructions.

As further illustrated in FIG. 15, the computing device 1500 may include a network interface 1506 comprising one or more components for communicating with other devices over a network. Examples of the present disclosure may access basic services that utilize the network interface 1506 to perform communications using common network protocols. The network interface 1506 may also include a wireless network interface configured to communicate via one or more wireless communication protocols, such as Wi-Fi, 2G, 3G, LTE, WiMAX, Bluetooth, Bluetooth low energy, and/or the like. As will be appreciated by one of ordinary skill in the art, the network interface 1506 illustrated in FIG. 15 may represent one or more wireless interfaces or physical communication interfaces described and illustrated above with respect to particular components of the computing device 1500.

In the example depicted in FIG. 15, the computing device 1500 also includes a storage medium 1504. However, services may be accessed using a computing device that does not include means for persisting data to a local storage medium. Therefore, the storage medium 1504 depicted in FIG. 15 is represented with a dashed line to indicate that the storage medium 1504 is optional. In any event, the storage medium 1504 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

Suitable implementations of computing devices that include a processor 1502, system memory 1510, communication bus 1508, storage medium 1504, and network interface 1506 are known and commercially available. For ease of illustration and because it is not important for an understanding of the claimed subject matter, FIG. 15 does not show some of the typical components of many computing devices. In this regard, the computing device 1500 may include input devices, such as a keyboard, keypad, mouse, microphone, touch input device, touch screen, tablet, and/or the like. Such input devices may be coupled to the computing device 1500 by wired or wireless connections including RF, infrared, serial, parallel, Bluetooth, Bluetooth low energy, USB, or other suitable connections protocols using wireless or physical connections. Similarly, the computing device 1500 may also include output devices such as a display, speakers, printer, etc. Since these devices are well known in the art, they are not illustrated or described further herein.

While the concepts of the present disclosure are susceptible to various modifications and alternative forms, specific examples thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one example,” “an example,” etc., indicate that the example described may include a particular feature, structure, or characteristic, but every example may or may not necessarily include that particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C).

Language such as “up”, “down”, “left”, “right”, “first”, “second”, etc., in the present disclosure is meant to provide orientation for the reader with reference to the drawings and is not intended to be the required orientation of the components or graphical images or to impart orientation limitations into the claims.

In the drawings, some structural or method features may be shown in specific arrangements and/or orderings. However, it should be appreciated that such specific arrangements and/or orderings may not be required. Rather, in some examples, such features may be arranged in a different manner and/or order than shown in the illustrative FIG. Additionally, the inclusion of a structural or method feature in a particular FIG. is not meant to imply that such feature is required in all examples and, in some examples, it may not be included or may be combined with other features.

As used herein, the terms “about”, “approximately,” etc., in reference to a number, is used herein to include numbers that fall within a range of 10%, 5%, or 1% in either direction (greater than or less than) the number unless otherwise stated or otherwise evident from the context (except where such number would exceed 100% of a possible value).

Where electronic or software components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

“Longitudinal” means a horizontal direction along the length of the conveyor, or parallel to that length. “Transverse” is a horizontal direction perpendicular to longitudinal.

“Downstream” is the longitudinal direction in which the product moves; “upstream” is the opposite.

Headings of sections provided in this patent application and the title of this patent application are for convenience only and are not to be taken as limiting the disclosure in any way.

While preferred examples of the present invention have been shown and described herein, it will be apparent to those skilled in the art that such examples are provided by way of example only. Numerous variations, changes, and substitutions will now occur to those skilled in the art without departing from the invention. Various alternatives to the examples of the invention described herein may be employed in practicing the invention. It is intended that the following claims define the scope of the invention and that methods and structures within the scope of these claims and their equivalents be covered thereby.

1. A linear coating apparatus configured to apply coating to a food product passing therethrough, the linear coating apparatus comprising:
a conveyor system supported in a frame and configured to move a food product along a conveyance path from an infeed end to a discharge end;
a coating assembly configured to apply a layer of coating to the food product as the food product is moved along the conveyance path, wherein after passing through the coating assembly the food product is a coated food product having a layer of coating; and
a texturizing assembly configured to impart a texture to the layer of coating, the texturizing assembly comprising:
a selective compression assembly having at least first and second rotating cylindrical wheels each having a length extending substantially across a width of the conveyor system, the at least first and second rotating cylindrical wheels spaced horizontally along a length of the conveyor system, the first rotating cylindrical wheel configured to apply at least a first tangential force to the coated food product as the coated food product travels by gravity through the selective compression assembly and the second rotating cylindrical wheel configured to apply at least a second tangential force to the coated food product as the coated food product travels by gravity through the selective compression assembly, wherein the at least first and second tangential forces apply compression to at least one of the layer of coating and the food product for creating a texture in the layer of coating; and
an infeed assembly configured to deposit the coated food product vertically above an infeed end of the selective compression assembly with a trajectory;
wherein the coated food product having a texture in the layer of coating, after passing through the selective compression assembly, is deposited onto the conveyor system.

2. The linear coating apparatus of claim 1, wherein the coated food product engages the first rotating cylindrical wheel before engaging the second rotating cylindrical wheel, and wherein the first tangential force applied to the coated food product causes the coated food product to move toward the second rotating cylindrical wheel.

3. The linear coating apparatus of claim 1, wherein the second tangential force applied to the coated food product causes the coated food product to move back toward the first rotating cylindrical wheel.

4. The linear coating apparatus of claim 3, further comprising third and fourth rotating cylindrical wheels each having a length extending substantially across a width of the conveyor system, the third and fourth rotating cylindrical wheels spaced vertically from the first and second rotating cylindrical wheels, horizontally from each other along a length of the conveyor system, and staggered horizontally relative to the first and second rotating cylindrical wheels, the third rotating cylindrical wheel configured to apply at least a third tangential force to the coated food product as the coated food product travels by gravity through the selective compression assembly and the fourth rotating cylindrical wheel configured to apply at least a fourth tangential force to the coated food product as the coated food product travels by gravity through the selective compression assembly, wherein the at least third and fourth tangential forces apply compression to at least one of the layer of coating and the food product for creating a texture in the layer of coating.

5. The linear coating apparatus of claim 4, wherein the coated food product engages the third rotating cylindrical wheel before engaging the fourth rotating cylindrical wheel, and wherein the third tangential force applied to the coated food product causes the coated food product to move toward the fourth rotating cylindrical wheel.

6. (canceled)

7. The linear coating apparatus of claim 4, wherein the second rotating cylindrical wheel is located horizontally upstream from the first rotating cylindrical wheel, the third rotating cylindrical wheel is located horizontally downstream from the second rotating cylindrical wheel and upstream from the first rotating cylindrical wheel, and the fourth rotating cylindrical wheel is located downstream from the first rotating cylindrical wheel.

8. The linear coating apparatus of claim 7, wherein at least one of the first, second, third, and fourth rotating cylindrical wheels includes an outer surface contour having axial protrusions and axial valleys extending along the length of the wheel.

9. (canceled)

10. The linear coating apparatus of claim 1, further comprising an excess coating removal assembly located downstream of the coating assembly and configured to remove excess coating from the coated food product.

11. (canceled)

12. The linear coating apparatus of claim 10, wherein the excess coating removal assembly includes a dust evacuation assembly having a nozzle extending substantially across the width of the conveyor system and configured to remove excess coating from a discharge end of the conveyor system.

13-14. (canceled)

15. The linear coating apparatus of claim 1, wherein
the conveyor system comprises:
an upstream conveyor system moveable between a first, substantially horizontal configuration and a second, lifted configuration configured to convey food products toward the texturizing assembly without changing an overall footprint of the linear coating apparatus; and
a downstream conveyor system in substantially linear alignment with the upstream conveyor system when the upstream conveyor system is in the first, substantially horizontal configuration, wherein the downstream conveyor system and the upstream conveyor system define the conveyance path between the infeed end and the discharge end when the upstream conveyor system is in the first, substantially horizontal configuration.

16-25. (canceled)

26. A dual function linear coating apparatus configured to apply coating to a food product passing therethrough in first and second configurations and to selectively apply texture to the coating of the food product in the second configuration, the linear coating apparatus comprising:
a conveyor system supported in a frame and configured to move a food product along a conveyance path from an infeed end to a discharge end, the conveyor system comprising:
an upstream conveyor system moveable between a first, substantially horizontal configuration and a second, lifted configuration; and
a downstream conveyor system in substantially linear alignment with the upstream conveyor system when the upstream conveyor system is in the first, substantially horizontal configuration, wherein the downstream conveyor system and the upstream conveyor system define the conveyance path between the infeed end and the discharge end when the upstream conveyor system is in the first, substantially horizontal configuration;
a coating assembly configured to apply a layer of coating to the food product as the food product is moved along the conveyance path; and
a texturizing assembly configured to impart a texture to the layer of coating, the texturizing assembly comprising:
a selective compression assembly having at least first and second rotating cylindrical wheels each having a length extending substantially across a width of the conveyor system, the at least first and second rotating cylindrical wheels spaced horizontally along a length of the conveyor system, the first rotating cylindrical wheel configured to apply at least a first tangential force to the coated food product as the coated food product travels by gravity through the selective compression assembly and the second rotating cylindrical wheel configured to apply at least a second tangential force to the coated food product as the coated food product travels by gravity through the selective compression assembly, wherein the at least first and second tangential forces apply compression to at least one of the layer of coating and the food product for creating a texture in the layer of coating; and
an infeed assembly configured to deposit the coated food product vertically above an infeed end of the selective compression assembly with a trajectory;
wherein the upstream conveyor system conveys the coated food product to the infeed assembly when the upstream conveyor system is in the second, lifted configuration, and
wherein the coated food product having a texture in the layer of coating, after passing through the selective compression assembly, is deposited onto the downstream conveyor system.

27. The linear coating apparatus of claim 26, wherein the coated food product engages the first rotating cylindrical wheel before engaging the second rotating cylindrical wheel, and wherein the first tangential force applied to the coated food product causes the coated food product to move toward the second rotating cylindrical wheel.

28. (canceled)

29. The linear coating apparatus of claim 26, further comprising third and fourth rotating cylindrical wheels each having a length extending substantially across a width of the conveyor system, the third and fourth rotating cylindrical wheels spaced vertically from the first and second rotating cylindrical wheels, horizontally from each other along a length of the conveyor system, and staggered horizontally relative to the first and second rotating cylindrical wheels, the third rotating cylindrical wheel configured to apply at least a third tangential force to the coated food product as the coated food product travels by gravity through the selective compression assembly and the fourth rotating cylindrical wheel configured to apply at least a fourth tangential force to the coated food product as the coated food product travels by gravity through the selective compression assembly, wherein the at least third and fourth tangential forces apply compression to at least one of the layer of coating and the food product for creating a texture in the layer of coating.

30-33. (canceled)

34. The linear coating apparatus of claim 26, wherein the coating assembly comprises:
a bottom coating assembly configured to apply a bottom layer of coating to the food product as the food product is moved along the conveyance path; and
a top coating assembly configured to apply a top layer of coating to the food product as the food product is moved along the conveyance path, wherein after passing through the bottom and top coating assemblies the food product is a coated food product having a top and bottom layer of coating.

35-39. (canceled)

40. The linear coating apparatus of claim 26, wherein
the infeed assembly for the texturizing assembly includes a feed conveyor configured to receive food products from a discharge end of the upstream conveyor system when the upstream conveyor system is in the second, lifted configuration, wherein the feed conveyor is moveable between first and second configurations to accommodate movement of the upstream conveyor system between the first, substantially horizontal configuration and the second, lifted configuration.

41. The linear coating apparatus of claim 40, wherein the feed conveyor is moveable with the upstream conveyor system between the first, substantially horizontal configuration and the second, lifted configuration.

42. The linear coating apparatus of claim 41, wherein an upstream end of the feed conveyor is moveably coupled to the upstream conveyor system, and the feed conveyor pivots about a downstream end of the feed conveyor to allow the feed conveyor to move with the upstream conveyor system between the first, substantially horizontal configuration and the second, lifted configuration.

43. (canceled)

44. The linear coating apparatus of claim 26, wherein the upstream conveyor system includes an endless, pervious conveyor belt supported by a plurality of rollers and having a first upper belt run extending between first and second rollers along the conveyance path of the conveyor system when the upstream conveyor system is in the first, substantially horizontal configuration and extending diagonally upwardly toward the texturizing assembly when the upstream conveyor system is in the second, lifted configuration.

45. The linear coating apparatus of claim 44, wherein the upstream conveyor system moves into the second, lifted configuration by pivoting the first upper belt run about a pivot axis defined by the first roller.

46-49. (canceled)

50. A method of texturizing a coated food product, comprising:
conveying a coated food product having a layer of coating to a texturizing assembly located above a conveyor system of a coating apparatus;
depositing the coated food product into the texturizing assembly with a trajectory;
applying at least first and second tangential forces to the coated food product as the coated food product travels by gravity through the texturizing assembly, wherein the at least first and second tangential forces apply compression to at least one of the layer of coating and the food product for creating a texture in the layer of coating; and
depositing the coated food product having texture in the layer of coating onto the conveyor system.

51-81. (canceled)
